(19) United States
(12) Patent Application Publication
(10) Pub. No.: US 2014/0258146 A1
(43) Pub. Date: Sep. 11, 2014

(54) SYSTEMS AND METHODS FOR PATENT PORTFOLIO MANAGEMENT AND GENERATION OF ANALYTICS

(71) Applicant: Black Hills IP Holdings, LLC, Minneapolis, MN (US)

(72) Inventors: Steven W. Lundberg, Edina, MN (US); Mark D. Stignani, Minneapolis, MN (US)

(73) Assignee: Black Hills IP Holdings, LLC, Minneapolis, MN (US)

(21) Appl. No.: 14/264,571

(22) Filed: Apr. 29, 2014

Related U.S. Application Data
(63) Continuation of application No. 13/956,162, filed on Jul. 31, 2013.
(60) Provisional application No. 61/691,182, filed on Aug. 20, 2012.
(60) Provisional application No. 61/814,073, filed on Apr. 19, 2013.
(60) Provisional application No. 61/814,937, filed on Apr. 23, 2013.

(51) Int. Cl. G06Q 50/18; G06Q 10/10

(52) U.S. Cl. CPC G06Q 50/184; G06Q 10/10
USPC 705/310

(57) ABSTRACT

Systems and methods for patent portfolio management and generation of analytics are described. A system comprises, for example, one or more modules. A first module is configured to combine data received from an official government source and from a docketing system. The data received may pertain to one or more assets of a patent portfolio. A second module is configured to generate a metric of the patent portfolio based on the combined data. The metric may measure a characteristic of the patent portfolio. A third module is configured to receive a request from a client device to display the metric. A fourth module is configured to, in response to the request to display the metric, display the metric in a user interface that includes one or more filtering elements that are selectable to request a filtering of the displayed metric.

### CLAIMS OF PRIORITY

This application is a continuation application and claims the benefit of priority to U.S. patent application Ser. No. 13/956,162, filed Jul. 31, 2013 (“SYSTEMS AND METHODS FOR PATENT PORTFOLIO MANAGEMENT AND GENERATION OF ANALYTICS”), which claims the benefit of priority, under 35 U.S.C. Section 119(e), of U.S. Provisional Patent Application Ser. No. 61/691,182 filed Aug. 20, 2012 (“SYSTEM AND MANAGEMENT FOR PATENT PORTFOLIO MANAGEMENT”), U.S. Provisional Patent Application Ser. No. 61/814,073 filed Apr. 19, 2013 (“SYSTEM AND METHOD FOR MANAGEMENT OF A PATENT PORTFOLIO”), and U.S. Provisional Patent Application Ser. No. 61/814,937 filed Apr. 23, 2013 (“PATENT CLAIM SCOPE EVALUATOR”), the contents of which are incorporated herein by reference in their entireties.

### BACKGROUND

The management of a patent portfolio involves multiple stages. Initially, a decision is made as to what inventions are worth the investment of filing a patent application. Then, each filed patent application goes through prosecution with the patent office. Finally, for each patent that is allowed, maintenance fees must be paid at a variety of intervals to keep the patent in force.

### BRIEF DESCRIPTION OF DRAWINGS

Some embodiments are illustrated by way of example and not limitation in the figures of the accompanying drawings in which:

FIG. 1 is a system component diagram, according to some example embodiments.

FIG. 2 is a block diagram of a patent portfolio management system, according to some example embodiments.

FIG. 3 is a user interface, according to some example embodiments.

FIGS. 4-53 illustrate sample aspects of user interfaces, according to some example embodiments.

FIG. 54 is a block diagram of machine in the example form of a computer system within which a set instructions, for causing the machine to perform any one or more of the methodologies discussed herein, may be executed.

### DETAILED DESCRIPTION

The life cycle of a patent may include multiple stages. These stages generally include invention, filing a patent application on the invention, prosecuting the patenting application to allowance or abandonment, determining whether to file any continuing applications, and paying maintenance fees on the allowed patent.

At each stage, one or more parties determine the best course of action to take with respect to the invention. For example, when determining whether or not to file a patent, the inventor may know what products are out in the technology area of the invention, a business manager may know how the invention fits in with a company's goals, and a patent attorney may have researched existing patents or application in the technology area of the patent. These parties will ultimately make the decision whether it is worth the initial investment of filing an application on the invention and then at each future stage determine the next course of action.

By performing analysis of a whole portfolio of patent related data, such as patents, applications, unfiled applications, and disclosures (collectively referred to as an innovation estate), a full picture of a portfolio can be viewed and understood with greater clarity from both a quantitative and qualitative sense. To fully understand a patent portfolio, the published, unpublished, and unfiled applications (e.g., disclosures) must be viewable in a combined and combined segregated mode. The combined segregated mode is a portfolio viewing mode that allows the viewing of all disclosures, applications, patents overlaid in relation to each other. Bibliographic evidence that may be used to describe full statistical views of a portfolio may be described as quantitative analysis. Examples of bibliographic data include class codes/estimated class codes, topical classifications (comprising key word, support vector, and hand classified data sets), priority dates, claim statistical information, and other bibliographic dates.

In various embodiments, a patent portfolio management system (hereinafter also “patent management system”, “portfolio management system”, or simply “system”) includes tools to help the parties involved in the patenting process make decisions at each stage of a patent asset's life. These tools may also be used for general research by parties not immediately involved with the patenting of the invention. Additionally, these tools may be used as standalone tools, in combination with other tools, and in combination with other patent portfolio management systems. Examples of tools include, but are not limited to prosecution analytics, reference management, prior art analytics, docketing management, claim mapping, claim analytics, portfolio analytics, internal (e.g., docketing system) and external database (e.g., PAIR) analytics, annuity management, market analysis, user interfaces (also known as “UIs”), competitive analysis, and strategic monitoring.

In some example embodiments, a user interface (e.g., a dashboard tool) may be used to display various metrics (e.g., prosecution metrics) for a particular matter in a patent portfolio, for slices of the portfolio, or for an entire portfolio. The dashboard may show, for example, views of bibliographic data in a) time ranked analysis, b) quantity ranked analytics, and c) other ranked analytics (e.g., assignee, class code, topical, or claim axis in relation to the other quantitative information available). The dashboard also allows slicing of the complete portfolio to determine groupings of the innovation estate that comprises a) old technology innovation that may be ready to sunset, sell or abandon, b) current innovation covering current and near future products or service, and ideation covering future plans and strategy of the company. This qualitative analysis requires further classification by human or statistical means to arrive at patent mappings that reflect the breadth of patent claims (e.g., as defined by Claimbot® mapping techniques, or patent file history summarizations showing limitations accepted in prosecution.)

The complete view (or the sliced view) of a portfolio may be then contrasted and overlaid with a portfolio held by a competitor or held by the marketplace of the products covered by the portfolio. Because the dashboard may slice (e.g., selectively segment particular types of data from) PAIR/Docket information of both competitor and the present portfolio, the dashboard may be used for more accurate research and development (R&D) budget planning, litigation response strategy, competitive technology analysis, acquisition analysis, portfolio maintenance cost management, or licensing revenue evaluation. By allowing the overlay of multiple layers and complexities of data, the dashboard also allows the simple visualization of the innovation estate performance, technological innovation monitoring, and technological forecasting. In addition, the dashboard may be used to determine where to leverage a company's decision-making process (e.g., where/when to invest) and to communicate the need for effective defensive tactics (e.g., to a user of the dashboard).

In some example embodiments, a system comprises, for example, one or more modules. A first module is configured to combine data received from an official government source and from a docketing system. The data received may pertain to one or more assets of a patent portfolio. A second module is configured to generate a metric of the patent portfolio based on the combined data. The metric may measure a characteristic of the patent portfolio. A third module is configured to receive a request from a client device to display the metric. A fourth module is configured to, in response to the request to display the metric, display the metric in a user interface that includes one or more filtering elements that are selectable to request a filtering of the displayed metric.

In various example embodiments, one or more modules of the system are configured to receive a filtering request to filter the displayed metric, the filtering request including an identifier of a filtering criterion; identify one or more discoverable features of the metric based on applying the filtering criterion to the combined data; and display the one or more discoverable features of the metric in response to the filtering request.

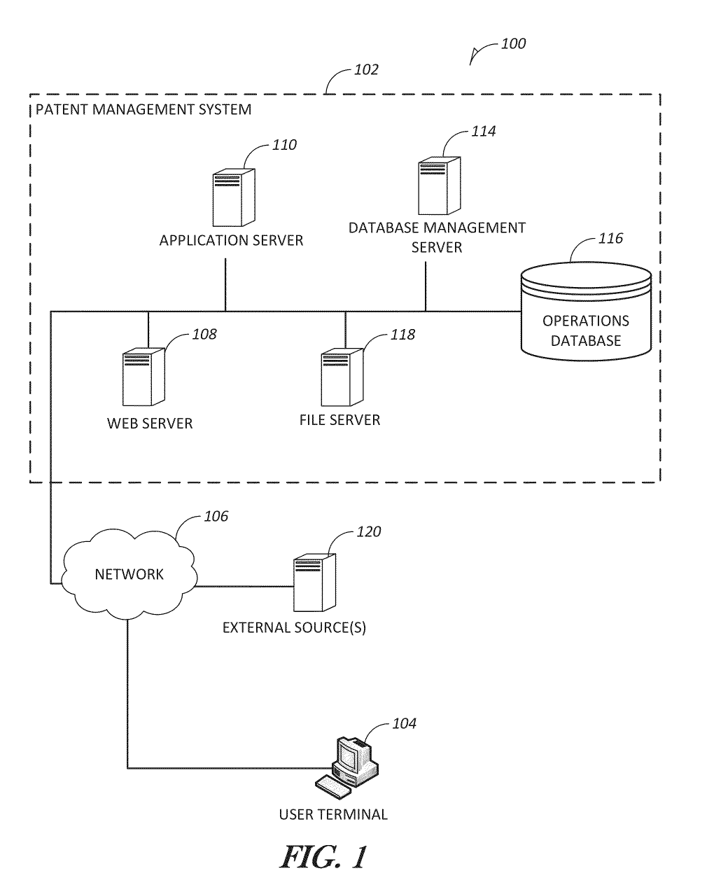

FIG. 1 is a schematic view of computer network system 100 according to various example embodiments. The computer network system 100 includes patent management system 102 (hereinafter also “patent portfolio management system 102” or “portfolio management system 102”) and user terminal 104 communicatively coupled via network 106. In some example embodiments, patent management system 102 includes web server 108, application server 110, database management server 114, which may be used to manage at least operations database 116 and file server 118. Patent management system 102 may be implemented as a distributed system. For example, one or more elements of the patent management system 102 may be located across a wide-area network from other elements of patent management system 102. As another example, a server (e.g., web server 108, file server 118, or database management server 114) may represent a group of two or more servers, cooperating with each other, provided by way of a pooled, distributed, or redundant computing model.

Network 106 may include local-area networks (LAN), wide-area networks (WAN), wireless networks (e.g., 802.11 or cellular network), the Public Switched Telephone Network (PSTN) network, ad hoc networks, personal area networks (e.g., Bluetooth) or other combinations or permutations of network protocols and network types. The network 106 may include a single local area network (LAN) or wide-area network (WAN), or combinations of LAN's or WAN's, such as the Internet. The various devices/systems coupled to network 106 may be coupled to network 106 via one or more wired or wireless connections.

Web server 108 may communicate with file server 118 to publish or serve files stored on file server 118. Web server 108 may also communicate or interface with the application server 110 to enable web-based applications and presentation of information. For example, application server 110 may consist of scripts, applications, or library files that provide primary or auxiliary functionality to web server 108 (e.g., multimedia, file transfer, or dynamic interface functions). Applications may include code, which when executed by one or more processors, run the tools of patent management system 102. In addition, application server 110 may also provide some or the entire interface for web server 108 to communicate with one or more of the other servers in patent management system 102 (e.g., database management server 114).

Web server 108, either alone or in conjunction with one or more other computers in the patent management system 102, may provide a user-interface to user terminal 104 for interacting with the tools of patent management system 102 stored in application server 110. The user-interface may be implemented using a variety of programming languages or programming methods, such as HTML (HyperText Markup Language), VBScript (Visual Basic® Scripting Edition), JavaScript™, XML® (Extensible Markup Language), XSLT™ (Extensible Stylesheet Language Transformations), AJAX (Asynchronous JavaScript and XML), Java™, JFC (Java™ Foundation Classes), and Swing (an Application Programming Interface for Java™).

User terminal 104 may be a personal computer or mobile device. In some example embodiments, user terminal 104 includes a client program to interface with patent management system 102. The client program may include commercial software, custom software, open source software, freeware, shareware, or other types of software packages. In some example embodiments, the client program includes a thin client designed to provide query and data manipulation tools for a user of user terminal 104. The client program may interact with a server program hosted by, for example, application server 110. Additionally, the client program may interface with database management server 114.

Operations database 116 may be composed of one or more logical or physical databases. For example, operations database 116 may be viewed as a system of databases that when viewed as a compilation, represent an “operations database.” Sub-databases in such a configuration may include a matter database, a portfolio database, a user database, a mapping database and an analytics database. Operations database 116 may be implemented as a relational database, a centralized database, a distributed database, an object oriented database, or a flat database in various embodiments.

In various embodiments, the tools of the patent portfolio management system share a common framework. The framework may have a base organization unit of a matter. In various example embodiments, a matter is an issued patent or patent application that includes one or more patent claims. In some example embodiments, a matter is generally identified by its patent number or publication number. Identification may mean either identification as it relates to a user of the patent portfolio management system or within the patent portfolio management system. Thus, a user may see a matter listed as its patent number while internally a database of the patent portfolio management system may identify it by a random number. One or more matters may be associated with prior art or cited references stored in a reference or prior art database.

One or more matters may be grouped together to form a portfolio. A matter may also be associated with one or more other matters in a family. A family member may be a priority matter, a continuing (e.g., continuation, divisional) matter, or foreign counter-part member. Family members may be determined according to a legal status database such as INPADOC.

Data stored in a first database may be associated with data in a second database through the use of common data fields. For example, consider entries in the matter database formatted as [Matter ID, Patent Number] and entries in the portfolio database formatted as [Portfolio ID, Matter ID]. In this manner, a portfolio entry in the portfolio database is associated with a matter in the matter database through the Matter ID data field. In various embodiments, a matter may be associated with more than one portfolio by creating multiple entries in the portfolio database, one for each portfolio the matter is associated with. In other embodiments, one or more patent reference documents may be associated with a patent by creating multiple entries in the patent database, for example. The structure of the database and format and data field titles are for illustration purposes and other structures, names, formats may be used. Additionally, further associations between data stored in the databases may be created as discussed further herein.

During operation of patent management system 102, data from multiple data sources (internal and external) is imported into or accessed by the operations database 116. Internal sources may include data from the various tools of the patent management system (e.g., an internal docketing system). External sources 120 may include websites or databases associated with foreign and domestic patent offices, assignment databases, WIPO, and INPADOC. In various embodiments, the data is scraped and parsed from the websites if it is unavailable through a database. The data may be gathered using API calls to the sources when available. The data may be imported and stored in the operations database on a scheduled basis, such as weekly, monthly, quarterly, or some other regular or periodic interval. Alternatively, the data may be imported on-demand. In some example embodiments, the data may be received as raw HTML, as part of a data feed or a spreadsheet.

After data importation, the data may be standardized into a common format. For example, database records from internal or external sources may not be in a compatible format with the operations database. Data conditioning may include data rearrangement, normalization, filtering (e.g., removing duplicates), sorting, binning, or other operations to transform the data into a common format (e.g., using similar date formats and name formats). In some example embodiments, subsets (e.g., portions) of the data received from external an internal sources are comingled to facilitate the functionality of one or more tools of the system.

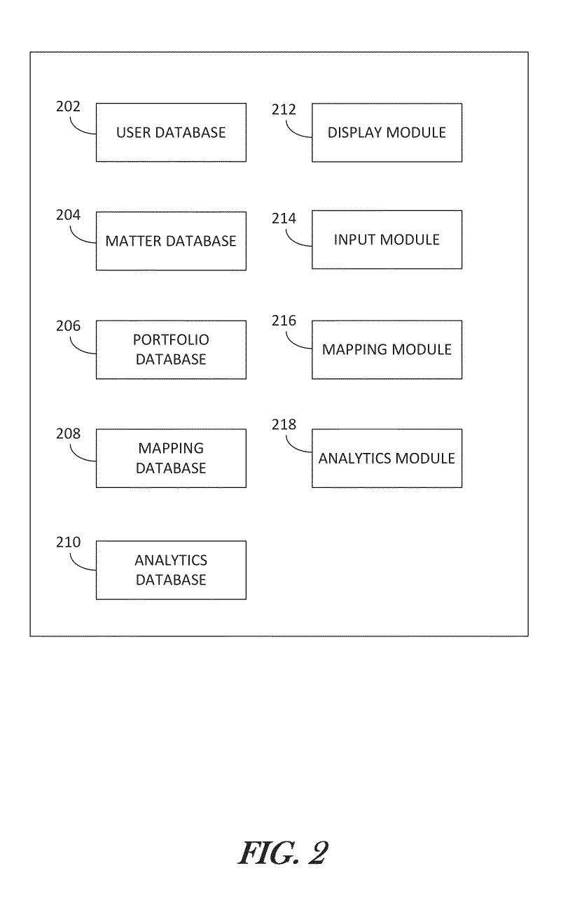

FIG. 2 is a block diagram of patent management system 102, according to some example embodiments. Illustrated are user database 202, matter database 204, portfolio database 206, mapping database 208, analytics database 210, display module 212, input module 214, mapping module 216, and analytics module 218. In various embodiments, the data stored in databases 202, 204, 206, 208, and 210 may be in the same or multiple physical locations. For example, portfolio database 206 may be stored in one or more computers associated with a portfolio management service. In various embodiments, patent management system 102 mirrors databases stored in other locations. In some example embodiments, when a request is made to access data stored in the databases, patent management system 102 determines where the data is located and directs the request to the appropriate location. Similarly, modules 212-218 may be executed across multiple computer systems.

In certain example embodiments, user database 202 stores data representing users of patent management system 102. The data may include data fields of user credentials including a user ID and password and access rights with respect to patent management system 102. The user ID may be common across the tools of the patent management system. In this manner, access rights of the user with respect to the tools of the patent portfolio management system may follow across the various tools of the patent management system. In some example embodiments, different access rights are granted to a user ID between the various tools.

In various embodiments, each user ID has access rights to one or more matters. Similarly, a user ID may have portfolio level access rights. Access rights may be defined according to at least two parameters: read access and write access. Thus, when a user logs into patent management system 102, the user is presented with access only to the matters/portfolios that have been associated with the user ID. More (e.g., additional contact information) or fewer data fields associated with a user may be included in a user entry stored in user database 202. In some example embodiments, matter database 204 stores data representing matters. Each matter may be associated with one or more portfolios. In some embodiments, a matter is associated with no portfolios. In various embodiments, a matter is a foreign or domestic patent or application. Matters may also be inventions that have not yet been filed (e.g., as may be the case within a docketing system). In some example embodiments, a matter entry includes data fields representing a matter ID, patent number, publication number, serial number, docketing number, title (e.g., the name of the patent or application), type of the matter (e.g., application, issued patent, PCT application), status of the matter (e.g., issued, abandoned, allowed), a link to the patent office where the matter was filed, a link to a PDF download of the matter, abstract of the matter, one or more claims of the matter, one or more drawings of the matter, inventors of the matter, current owner of the matter, cited references on the face of the matter, filed date, issue date, docket number, various prosecution metrics (e.g., number of office actions received, number of examiner interviews held, or number of Requests for Continued Examination (also known as “RCE(s)”) filed), and annuity information (e.g., due date, country, and amount due). In some embodiments, other patent reference documents or prior art in any form may be stored and associated with one or more matters. More or fewer data fields associated with a patent may be included in a matter entry stored in matter database 204. In an example embodiment, matter database 204 may store a patent matter database, wherein this database includes data about the patent matters. The data may include, for at least one patent matter, a claim set or statement of invention and a priority date for the claim set or statement of invention. Matter database 204 may also store a database of prior art documents (also known as “references”), wherein the prior art database includes data about the prior art documents. The data may include, for at least one prior art document, a priority date or publication date of the document. One or more of the prior art documents may be associated with a first patent matter in the patent matter database.

In various embodiments, a matter is associated with one or more other matters as a family with a family ID. Family members may be priority documents, continuation patents/applications, divisional patents/applications, and foreign patent/application counterparts. In an embodiment, family information is determined according to an external source such as INPADOC. Patent reference documents and/or other prior art may be manually or automatically stored, cross-cited and associated with related family matters, for example.

Portfolio database 206, in an example embodiment, stores data representing portfolios of one or more matters. Data stored in portfolio database 206 may have been previously generated by a tool of patent management system 102. In various embodiments, a portfolio may be generated by a user using patent management 102. For example, a user interface (e.g., a dashboard) may be presented to the user requesting a name for the portfolio and identifiers of matters to be included in the portfolio. In an embodiment, a portfolio entry in portfolio database 206 includes data fields of portfolio ID and a portfolio name. Additionally, a data field for a matter ID may also be included in an entry in the portfolio database. Thus, each portfolio may be associated with one or more matters through the use of the matter ID data field. More or fewer data fields associated with a portfolio may be included in a portfolio entry of portfolio database 206.

In an example embodiment, mapping database 208 includes mappings of scope concepts, technology categories, and keywords to one or more matters. In an embodiment, a scope concept is a textual description of what a patent claim is at least limited to. Thus, if a claim comprises A, B, & C, a scope concept may be A. In various embodiments, a scope concept for the claim may be broader than A because the claim will still be limited to the broader scope concept. In an embodiment, the mapping database stores mappings between claims and scope concepts. A technology category mapping may indicate that a claim is in a certain technology area. A keyword mapping may indicate that there is an exact match between the keyword and a subset (e.g., a word) of the claim language.

In various embodiments, analytics database 210 stores data representing analytics calculated based on data stored within patent management system 102 or external data sources. In various embodiments, analytics are organized according to an individual matter, portfolio, family, company, or product. The calculated analytics may be based on information gathered from multiple sources such as databases of patent management system 102 (e.g., a database related to the internal docketing system) and PAIR.

In various embodiments, information for an individual matter may include status (e.g., disclosure received, drafting, filed, completed-waiting examination, in prosecution, allowed, or issued), cited prior art, list and type of rejections (e.g., 35 U.S.C. §101, §102, or §103), number of claims allowed, office action count, interviews held, IDS statements filed, attorney fees to date, and PTO fees to date. Further metrics for an individual matter stored in analytics database 210 may include time metrics and/or efficiency metrics such as time from disclosure to assignment, time from assignment to filing, total time from disclosure to filing, total time from disclosure to issue, time between the receipt of an office action and the filing of a response to the office action, time waiting for examiner (e.g., a decision of the examiner), total time in examination, time waiting for PTO while in examination, and time on appeal. Additional prosecution details for a matter may include upcoming docket dates (e.g., due dates for office action, IDS due dates, etc.). A claim prosecution history chart may also be stored in analytics database 210 for each matter. The prosecution history may include a history of claim amendments and arguments made in prosecution.

In various embodiments, portfolio and family analytics information may be stored in analytics database 210 based on aggregating the metrics for an individual matter. In an embodiment, the analytics of a family may differ from those in a portfolio as not all family member matters may be part of a portfolio. Additionally, the analytics may be stored for multiple time periods such that comparisons may be made between current metrics and, for example, metrics calculated a year ago (or other time period).

Aggregated metrics may be generated for a number (e.g., some or all) of the patents and applications in a portfolio based on a number of variety of criteria, such as pending or awaiting examination, in prosecution with no claims allowed, in prosecution with some claims allowed, appealed, notice of allowance received, or issued. These metrics may be compiled for both US and international matters in the portfolio. Additional information may include the international portfolio distribution by country. An age distribution of the portfolio may also be compiled. For example the portfolio may be broken down by less than one year old, 1 to 3 years old, 3 to 5 years old, 5 to 10 years old, 10 to 20 years old, and 20 or more years old. Recent filing and issue activity as well as upcoming Ford filing deadlines may be stored in analytics database 210.

In various embodiments, prosecution metrics across a portfolio, a portfolio segment (also known as “slice”), or family are determined and stored in analytics database 210. This data may include matters waiting for examination, matters in examination, matters appealed, and cases allowed but not yet issued. Analytics based on office actions may also be compiled and stored. For example, the cases that received a notice of allowance after a first office action response, a second response, etc., may be stored in analytics database 210. Additional prosecution analytics may include allowance rate (e.g., 10%) after a telephone interview, allowance after an in-person interview, percentage of interviews with response, number and type of rejection, average time in prosecution (e.g., in months), average time to file a response, and average time to next office action. Further, the list of matters in prosecution with a particular number of office action received, matters in prosecution with a particular number of RCE(s) filed, matters in prosecution with an examiner interview held after a particular office action, recently allowed cases, recently appealed cases, stalled cases (e.g., applications that received six or more office actions), and recently abandoned cases may also be stored for each portfolio, portfolio slice, or family in analytics database 210.

In various embodiments, the results of keyword analysis on one or more matters and/or prior art references may be stored in analytics database 210. The keyword analysis may be based on the occurrences of the keywords in the matter or references to derive a score or keyword overlap.

In various embodiments, data stored in the database for a group of matters in a portfolio, portfolio slice, or family is analyzed to determine the top (e.g., ten) most cited patents, the top inventors (e.g., the inventors with the largest number of matters in a portfolio, portfolio slice, or family), the top most cited inventors, top most cited prior art owners (e.g., according to assignment documents on the face of the patent), newly (e.g., within the last 60 days) cited prior art owners, and top most cited prior art inventors. This information may be stored in analytics database 210.

In an embodiment, display module 212 is configured to display user interfaces and information retrieved from one or more databases 202-210. If a user is accessing patent management system 102 remotely (e.g., through a web browser or an application of a mobile device) display module 212 may be configured to transmit data representing a user-interface through a network to a user terminal. In various embodiments, display module 212 is configured to generate one or more charts of data stored in databases 202-210. For example, display module 212 may generate a pie chart of the top 10 inventors within a portfolio or a pie chart of the distribution of patents or patent applications in a class of technology based on assignee names.

In various embodiments, input module 214 receives data from multiple sources where it may be further processed by one or more other modules and stored in one or more of databases 202-210. For example, input module 214 may be configured to utilize one or more APIs to access or receive data from one or more patent data stores (e.g., public PAIR, private PAIR, INPADOC, foreign patent offices, patent docketing systems, portfolio management systems, etc.) The data may include published patent documents, patent applications, office actions or other patent office correspondence, prior art references, claim mappings, dockets dates, and annuity payment data.

In various embodiments, input module 214 is configured to receive input from one or more user interface elements. For example patent management system 102 may present multiple user interfaces to a user. These user interfaces may enable users to input data directly into databases 202-210, instruct the patent management system to retrieve data from patent data stores, and instruct the patent management system to perform various operations on the data (e.g., generation, analysis, or presentation of metrics) in databases 202-210.

Additionally, input module 214 may be configured to determine the selection of one or more user interface elements by a user and initiate the action associated with (e.g., corresponding to) the selected user interface element. For example, a user interface element may include a drop-down menu to select a portfolio. Input module 214 may be configured to receive the selection of the portfolio by the user. Then, input module 214 may pass the selection to one or more other modules for further processing. For example, display module 214 may update the drop-down menu or another area of the user interface to indicate the selection of the portfolio or display some or all of the data pertaining to the selected portfolio.

In various embodiments, input module 214 processes the data that has been inputted and formats it according to the data fields of databases 202-210, as discussed above. In various example embodiments, processing is completed using a parsing module (not shown). For example, consider a patent publication that a user has directed to be inputted into one or more of the databases. The parsing module may use a combination of automatic image recognition and text analysis to determine the filing date, issue date, title, abstract, and claims of the patent. In some embodiments, the parsing module may flag certain pieces of data that had been determined to be potentially inaccurate (e.g., a number could not be read). In some example embodiments, a user of patent management system 102 may then examine the flagged data and manually enter the information which is then stored in the appropriate database.

The resulting data that has been parsed by the parsing module may then be entered as an entry in one or more of databases 202-210. This may be accomplished by, for example, formulating an insert SQL query with the parsed information. In various embodiments the parsing module may parse multiple piece of information before generating a database entry. For example, input module 214 may receive a docket number for an issued patent. The docket number may be combined with the information parsed from the issued patent to form an entry in matter database 204.

In various embodiments, mapping module 216 is configured to facilitate mappings of scope concept, technology categories, and keywords to patent claims of a matter. In an embodiment, mapping signifies association. For example, in conjunction with display module 212 and input module 214, mapping module 216 may present a user interface of patent claims stored in matter database 204 and scope concepts stored in mapping database 208. Input module 214 may receive a selection of one or more patent claims and one or more scope concepts and pass them to mapping module 216. Mapping module 216 may then formulate an SQL query to associate the one or more patents claims with the one or more scope concepts. When executed, the SQL query, may update the mapping database 208 with the associations. In various embodiments, mapping module 216 also allows the creation of new scope concepts, technology categories, and keywords that may be mapped to one or more patent claims. Furthermore, mapping module may present user interfaces that allow a user to rank and rate matters stored in matter database 204.

Mapping module 216 may also allow the generation of claim charts of a plurality of cells. A claim chart may include one or more scope concepts, technology categories, and keywords on one axis and claims of matters in a portfolio on the other axis. The claim chart may include a variety of levels of granularity of scope concepts. Some claims may be mapped to all of the scope concepts while others may not be mapped to any scope concepts. At the cell intersection between a scope concept (or technology category or keyword) and a claim, an indication of the mapping may be presented by changing the format of the cell. For example, the cell may be colored blue when a scope concept is mapped and red when not mapped.

In various embodiments, analytics module 218 is configured to examine and run calculations on the data stored in the databases 202-210 to generate the analytics discussed previously. For example, analytics module 218 may formulate an SQL query that retrieves the number of times that a prior art reference has been cited within a portfolio. This query may be run for each prior art cited within the portfolio to determine a list of the most cited (e.g., the top ten) prior art references with a portfolio. In some example embodiments, the queries are formulated and run as requested by a user. In certain example embodiments, the analytics are generated in response to a certain triggering event (e.g., based on one or more alerts). In an embodiment, once the analytics information has been determined, it is stored within analytics database 210. In various embodiments, queries are formulated and run on a periodic basis (e.g., nightly) and entries in analytics database 210 may be updated to reflect any changes.

In various embodiments, the analytics module 218 is configured to receive input identifying a pool of keywords for a first patent matter in matter database 206 and associated prior art documents in matter database 206. The term keyword is intended to include individual keywords as well as a number of keywords grouped together making up a key phrase, for example. The module 218 may be further configured to perform a keyword analysis on the first patent matter and associated prior art documents based on occurrences of the keywords in the first patent matter and associated prior art documents. The module 218 may be further configured to identify, based on the analysis, keywords occurring uniquely in the first patent matter. In view of their uniquely occurring nature, these keywords may be regarded as claim elements potentially differentiating the claim set or statement of invention over the disclosures contained in the one or more prior art documents.

In various embodiments, a filtering module is configured to filter a set of matters according to a user preference. For example, a user may activate a check box that indicates only pending matters should be shown in a user interface. The filtering module may formulate a query consistent with retrieving only pending matters. The results of the query may then be shared with display module 212 where the user interface may be updated. Examples of other filtering criteria that may be used with the portfolio management system are described below.

In various embodiments, a payment module is configured to receive selections by the user of which annuities to pay for matters in a portfolio. Additionally, the payment module may receive user preferences related to the payment of the annuities. The payment module may receive payment information from a user and forward the payment information to the appropriate agency/office. In some embodiments, annuity management system 102 organizes payment of the annuity on behalf of the user and the user pays annuity management system 102.

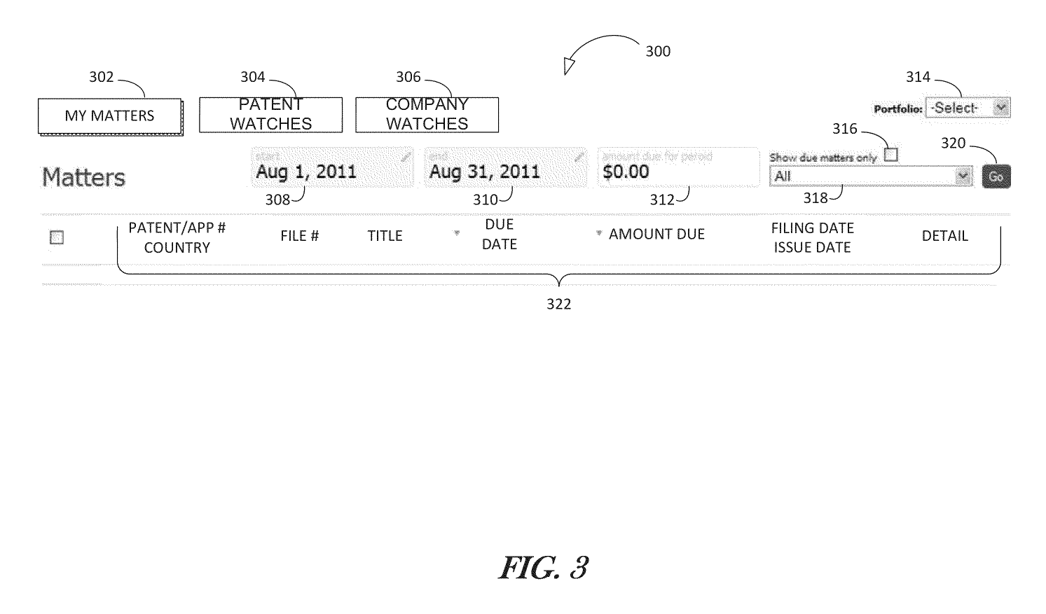

FIG. 3 is an example user interface 300 of patent management system 102 which may be used to facilitate the methods, tools and systems described herein. User interface 300 is illustrated with multiple user interface elements. In some example embodiments, a user interface element is a graphical or textual element that a user may interact with to cause an application to perform an assigned action for the interface element. Data representing user interface 300 may be transmitted via network 106 and presented on a display of user terminal 104, for example, through the use of a web browser. A user (e.g., manager of a patent portfolio) may interact with the user interface elements of user interface 300 through the use of an input device (e.g., stylus, cursor, mouse, finger, or voice) of the user terminal. In certain example embodiments, a user selection is based on the coordinates of the input device as it makes contact with the display or where a user “clicks” the mouse. The coordinates are compared to the coordinates of the user input element to determine the selection. The type of user elements, names, and layout depicted in FIG. 3 are intended to be an illustration of an example user interface of patent management system 102. Other types of user elements, names, and layouts may be used, as shown in the example illustrations below.

The user interface elements may include my matters 302, patent watches 304, and company watches 306. These elements may be used to select a context/view of the patent management system. For example, my matters lists the patents included within a portfolio of a user, patent watches lists information on patents that the user has indicated the patent management system is to watch, and company watches lists information on companies that the user has indicated the system should watch. Further details of each of these are included herein.

Date boxes 308 and 310 are user elements that allow a user to select a time period. Amount due box 312 displays the amount due with respect to annuities for patents in the portfolio of the user within the period indicated by date boxes 308 and 310. Upon activating (e.g., clicking) one of the date boxes, a user may be presented with a calendar which allows the selection of a date. Upon selecting a date, the date boxes will update to reflect the user's choice.

Drop-down menu 314 includes a list of portfolios that a user of the patent management system is authorized to view. For example, before user interface 300 is displayed, a login screen may be presented to the user which requests a user ID and password. In various embodiments, the user ID is associated with one or more portfolios. In turn, each portfolio is associated with one or more matters. Matters may include US and foreign issued patents, pending patents, abandoned patents, and not yet filed applications. Thus, upon selection of a portfolio using drop-down menu 314, user interface 300 is populated with matters associated with the portfolio.

Checkbox 316 is an option to only display matters that currently have an annuity due. Drop-down menu 318 allows further filtering of matters. For example, the matters may be filtered by US patents only, US patent applications, or foreign patent/patent applications only.

In various embodiments, activation of button 320 updates user interface 300 to reflect the choices made by the user with respect to date boxes 308 and 310, checkbox 316, and drop-down menu 318. For example, amount due box 312 will be updated to reflect the amount due within the new period and the matters listed under column headings 322 may be filtered. In various embodiments, user interface 300 is updated as the user selections are made with respect to elements 308 to 318 without activating button 320.

Various tools may be implemented using the system described above. In various example embodiments, a tool for dynamic management of a patent portfolio may be used with patent management system 102. Example users of the tool for dynamic portfolio management are a law firm, a client of a law firm, or a company's legal department. The portfolio management tool allows a user (e.g., a portfolio manager) to manage a portfolio (e.g., by generating and presenting analytics) by law firm, by portfolio, or by portfolio slice. The tool may allow a user to identify stuck or stale applications, determine competitor interest based on citation analysis (inbound and outbound), dynamically review other owners' portfolios, and set up watches and updates.

In various example embodiments, the portfolio management tool generates portfolio analytics based on input data received from at least one government source (e.g., PAIR data) and at least one internal system (e.g., data from a docketing system). In some instances, additional data may be used to supplement the PAIR data and the docketing data. A template load may be performed on a periodic basis (e.g., weekly, monthly, quarterly, annually, etc.) based on a client's needs for dynamic information. For example, the tool may automatically load a template spreadsheet of input data at a predetermined time. The received data may be combined and used in generating portfolio analytics for a matter, portfolio, portfolio slice, or family.

### Prosecution Analytics

Various prosecution analytics tools may be implemented using the system described above. Some of the tools are described below. In various example embodiments, a software tool to collect and present prosecution analytics may be used with patent management system 102. For example, a dashboard may be used to display various metrics (e.g., prosecution metrics) for a particular matter in a patent portfolio, for slices of the portfolio, or for an entire portfolio. For each matter, the dashboard may include docket dates as well as patent analytics.

In various example embodiments, analytics may include success rate(s) of responses based on the following:
a. Probability a response will result in allowance or other event;
   i. Responses of different types, e.g. non-final, final, after final;
   ii. Based on class/subclass;
   iii. Based on examiner;
   iv. Based on art unit;
   v. Based on number of prior responses;
   vi. Based on how long the case has been in active prosecution;
b. Analytics—success rates based on USPTO statistics or Attorney or Attorney Organization data;
   i. Probabilities of 2 for each—USPTO vs. Attorney vs. Attorney Org;
   ii. Compare both;
c. Analytics—success rates based on Owner of Patent/Invention;
d. Analytics—success rate based on type of owner—e.g., small or large entity;
e. Analytics—success rates based on Prior Art Owners;
f. Analytics—success rates based on length of claim;
g. Analytics—success rates based on number of words added to claim; h.
Analytics—success rates based on length of arguments;
i. Analytics—success rates based on type of rejection;
j. Analytics—success rates based on effective date of prior art; and
k. Analytics—success rate based on keyword/key phrase overlap between prior art and application specifications

In some example embodiments, additional analytics are displayed to a user based on analytics in a PAIR-like system (sometimes referred to as PAIR Plus): statistics for examiner or supervisor; statistics for art unit; statistics for class/subclass; or analytics on the prior art.

In various example embodiments, prosecution analytics are generated from PAIR and combined with information in an existing file management (e.g., docketing) system. The analytics may be combined to generate portfolio prosecution analytics metrics. Success rates may be checked based on results (e.g., correlate to attorneys and examiners).

In various example embodiments, a tool may be used to scrape PAIR references into prior art in matters. In some example embodiments, it may automatically cross-cite.

In some example embodiments, a tool may be used to: 1. Read PAIR; 2. See what new references add to prior art; 3. Examine the office action to find the grounds for rejection near the reference from the list.

In various example embodiments, a tool may present a claim chart matrix in which there is one column per PTO action; top of column each applied reference is listed in rows and denoted, for example, A, B, C; Each row below is claim and code for rejection type and reference.

In some example embodiments, a prosecution analytics software tool may scrape data from an office action into a portfolio. The patent claims may be entered in the “matters” list, and references may be entered in the “references” list. In some example embodiments, the art may be auto analyzed. In one example embodiment, a wizard may be provided to analyze the art. The tool may put links to pertinent law/rules. Analytics may be generated for each reference and show era of references. In some example embodiments, the software tool may send a link to the portfolio to an attorney.

In various example embodiments, a tool may, for any given patent, show a forward citation timeline, where the tool may include i. a timeline with a bar for each year the patent is forward cited (based on filing date of the forward cited patent); ii. each bar has a segment for each patent for that year (e.g., two segments for two forward cites in a year); and iii. each segment is “heat map” color coded based on—1) if citation was “applied” and 2) keyword overlap in technical field, abstract, claims. In some example embodiments, the tool may show a forward citation, where the tool may place all forward cites along the x axis and expand the graph downwardly for forward cites of the forward cites. In some example embodiments, this creates a two dimensional chart. In certain example embodiments, the forward cites of forward cites could be added in the same way as the forward cites to show growth in activity in an area.

### Reference Management

In various example embodiments, tools for prior art management are used in patent management system 102. In an example embodiment, in a matter management system (e.g., patent management system 102), there is a cross-citation control panel for citing prior art between cases. In various example embodiments, the control panel:
i. shows all cases to “send” art to or “receive” art from or both;
ii. allows user to set rules for sending or receiving based on;
   a. Number of time art has hopped already to get to the matter;
   b. Type of citation—102(b)/103;
iii. Cases to send or receive from can be automatically populated by family matters or other matters.
   The tool may also show citations pathway for each reference:
a. Where it started;
b. What it flowed through;

In various example embodiments, a prior management portfolio may be created by that has features of:
a. Loading Matters (pending or issued apps) into special “prior art management” portfolios;
b. Art automatically flow between Matters in a portfolio;
c. Art flows between portfolios via Matters listed in more than one portfolio;
d. Art is kept in list in Portfolio;
e. Not based on patent family or related cases necessarily—any arbitrary cases can be added;
f. Art displayed in each Matter can be filtered by:
   i. Cross-cited art (art arriving from other Matters);
      1. Number of hops to get to list;
      2. Type of rejection (102/103);
      3. Other analytics—see e.g., prior art analytics;
4. New art added to Portfolio;
g. Art can be added to Portfolio, in the Prior Art (called “references”) list;
   i. This art is not cross cited to other Matters in other portfolios until it is added first to a Matter to be cited or as cited;
   ii. This art is displayed for each Matter to be considered, as “new art” not yet cross-cited”

In various example embodiments, PAIR Plus may include:
a. Pair data;
b. Uncited art cross-reference;
c. Links to cases beyond PAIR;
d. Scanned docs;
e. Art analysis;
f. Art highlights;
g. Analytics with Actions;
h. Foreign cases;
i. Docket Dates for Matter—calculated by PAIR PLUS;
j. PAIR Process Options—process options for any given point in a case
k. Foreign PAIR; a. Aggregate of US and foreign PAIR

In various example embodiments, PAIR Plus may also automatically proof claims, scan amendments, assemble most recent claims, compare to issued patent, scan prior art, make a list of prior art, and compare it to the issued patent. Differences may be determined between the filed specification and issued specification. The differences may be presented to a user for review.

### Prior Art Analytics

In various example embodiments, a tool for analytics of prior Art includes:
a. Automatic keyword/key phrase differentiation;
   i. Create pool of keyword/key phrases for prior art and for pending application;
   ii. Note differentiating keyword/key phrases;
b. Automatic prior art ranking based on keyword/key phrase overlap;
   i. Art with most keyword/key phrase overlap is highest ranked;
   ii. Allow manual addition of synonyms to enhance analysis;
c. Prior art timeline graphs;
   i. Show timeline with dates of prior art vs. application;
   ii. Show timeline of all patents or applications in class/subclass, in comparison to pending application;
d. Keyword/key phrase timeline graphs;
   i. Show timeline of when keyword/key phrases of application first appeared in prior art;
   ii. Could be table/chart with keyword/key phrases listed by order of appearance by year, with representation of each year; and
e. Dominance of owners by keyword/key phrase—show which owners own most art with matching terminology (also for payment analytics).

In various example embodiments, an analytics tool may be used to determine prior art overlap. For example, competitor overlap for single patent, portfolio, or family may be include:
a. prior art citation overlap;
b. overlap of prior art cited against Target Company's patent or portfolio, and prior art cited against Competitor Company or Companies, identified by user;
c. an analytic result may include a list of prior art cited against both the Target and the Competitors;
d. an analytic result may include list of companies that own prior art cited against Target and Competitors (e.g., show the number of references cited against both owned by Target).

In various example embodiments, a process: 1) looks at a US patent and if it shows a reference was applied, gets name of company it was cited against and highlights that company as a target for the applied reference; 2) for applied references, crawls PAIR and OCR or otherwise reverse engineers the reason reference was cited, and pulls comments by PTO or attorney; and 3) takes note if it was a §102 reference or §103. Then, in various embodiments, the process does the same for foreign references of PCT search. For example, after determining if an applied reference was a 102/103 a tool may determine the name of the applied reference from the face of the patent and then look for text “102” or “103” near the reference in the ocrd text, or like in foreigns.

An output may include a chart with headings of Prior Art Reference, # Cited against Target, and #Cited against Competitor 1, 2, 3 with example entries:
Reference A, [x], [y, z, a . . . ]
Reference B, [e], [b, c, d]

In various example embodiments, a tool is used for prior art and forward reference citation analysis. The tool may generate a continuing stream of “watch results” for a single patent (or a group of patents). In an embodiment, there is a problem if an inventor or company sets up a watch to see if their patent is being cited by later-issued patents, many times no such cites occur for a long time, if at all. The tool helps produce a steady stream of watch results, on a daily/weekly/monthly basis. The tool may for: a. Forward cites of prior art: i. take the pool of all prior art cited on patent; ii. watch for forward cites of any of this art; iii. report these forward cites; b. Forward cites of applied prior art only: i. take pool of applied art cited on patent (USPTO puts asterisk on these); ii. watch for forward cites; iii. report these forward cites; c. Forward cites of patent being watched; i. this is prior art; d. Forward cites of forward cites; i. here we look at the forward cites of patent being watched; ii. report any forward cites of those references; e. forward cites of forward cites of prior art. In various embodiments, the display of these results can be dynamically determined based on the number of results available by: a. for example, may want to suppress presentation of more remotely relevant watch results if there are plenty of more pertinent watch results; b. or, list results in order of perceived pertinence; i. forward cites of watched patent of course most relevant; ii. perhaps forward cites of applied art next most relevant; iii. then, perhaps, forward cites of forward cites; iv. then, perhaps, forward cites of any prior art reference; F) Also, the tool can filter watch results from the company that owns the patent—so if the owner of the watched patent cites back to it, the tool may provided an option to ignore those results.

In various example embodiments, a prior art date analyzer is used to: a) In PAIR, using patent number, pull priority dates from PAIR or other source for US patent/application; and b) apply prior art rules to determine likely effective date of reference.

In some example embodiments, an office action workroom tool is used for analyzing cited prior art. The analytics may include 1) owners of art, 2) timing of art—timeline view, 3) timeline of art in art unit/class-subclass, 4) notable inventors, and 5) keyword overlap—unique keywords for case under rejection. In an embodiment, the prior art has been prepared (e.g., using OCR) for search. Then, a list of keywords may be run against the cited prior art. In an embodiment, the tool may generate a spreadsheet output with keywords mapped to paragraphs with analysis functions built in spreadsheet or may generate a spreadsheet with capabilities built into a web interface. The capabilities may be used to find which paragraphs or documents have certain combinations of keywords (a user may pick the combination of keywords). Also, a user may search for and map concepts to cited art that are not shown. Prior art rejections may be mapped to specific paragraphs of document and shown in workroom or in a spreadsheet. Examiner statistics may also be part of the office action room, or examples of other rejections by examiner. Other rejections on the same references, or reference history, may be shown as well.

In various example embodiments, a tool for analyzing cited prior art may be used for forward and backward citation coverage list analysis. In some example embodiments, the tool may, for all patents of a first owner or patents in a class for an owner, 1) determine a list of all the other owners of patents or applications that own a patent that has been cited against the first owner, and how many for each; 2) determine a list of all the other owners of patents or applications that own a patent that one or more of the patents of the first owner have been cited against (e.g., forward cites), and how many for each; 3) determine and/or display the above (e.g., based on year), for example, in a chart with owners in rows and each year in a column; and 4) determine biggest gainers/losers (e.g., by year).

In various example embodiments, a prior art analytics tool may have features of:

1. Multi-level forward/backward citation search and presentation; or

2. Synonym/antonym FTO.

### Docketing Management

In various example embodiments, the PAIR Plus tool may include a docket verification-docket built in. For example: a) PAIR or portions thereof may be scraped or copied; b) in particular, transaction log or log of office actions; c) a docket engine that may be part of the tool; d) the docket engine may determine a set of docket dates—response due dates etc., e) due dates may also be for foreign filing or prior art cross citation; f) those dates are associated with or embedded into a PAIR document; g) user may download the PAIR document and the due dates are either on a PDF or on an Excel or XML or other form with document; h) or, user can synchronize their Outlook calendar with PAIR due dates; i) If the tool does not know the date, the tool may flag that and add to calendar or list of exceptions as an exception that needs to be looked at; j) or, there may be a PAIR docket system that users may subscribe to and get a docket that is driven directly off of PAIR—(e.g., the tool can check things off as done once filed in PAIR); ii. and the tool can docket a date that is not a response date (e.g., foreign filing or as noted above, IDS cross cites); k) the PAIR docket can also check other related matters, and docket for prior art cross-citation if system sees references cited in related case.

In various example embodiments, to obtain some of the data above the tool may scrape or download PTO actions from foreign patent offices (either selectively or in bulk), OCR to get electronic data or reformat the downloaded electronic data, provide the electronic data to a user/operator of a docket system, and provide an import mechanism for the docket system, either as a BOT or through an API, to load docket information.

In various example embodiments, another tool of PAIR plus may include automatically OCR of all PAIR docs and provide word or PDF text doc versions of PTO docs to PAIR plus user and/or using automatic text analysis, the tool may extract details/types of PTO actions as well as references. This then is added to the data set for the patent, and delivered in PAIR plus. In an embodiment, PAIR plus looks similar to the traditional USPTO site but with extra metadata.

### User Interfaces

In various embodiments, for the tools discussed herein, one or more user interfaces (hereinafter also “UI(s)”) may be used to present portfolio analytics and to determine which services a user may elect. For example, 1) a user may load a list of US patent/application cases into a portfolio manager, 2) each patent/application may have the following button options: a) sign up/select option to find foreign equivalents or US family, and load if desired, a-1) sign up for title guard—a tool monitors title changes, b) sign up for maintenance fee payment alerts—a tool monitors for either payments due and/or send an alert if payment not made, c) a tool offers to make payment if one is due—this is done with multiple payment options; d) sign up for basic citation alerts—any forward cite, e) sign up for advanced citation alert—a tool looks at forward citations of related patents like citation of an applied or unapplied prior art reference, or a forward cite of a forward cited patent, or a forward cite of a sibling patent, e-1) sign up for PTO PAIR alerts, e-2) sign up to look for cites to the patent in pending applications, f) sign up for advanced metrics—a package of advanced analytics metrics, g) sign up for Internet watch for patent—set parameters to generate web hits that are related to the patent, h) sign up for troll/patent trading activity alert—a tool detects how many patents in the same class/subclass or in other related group have changed owners in a time period.

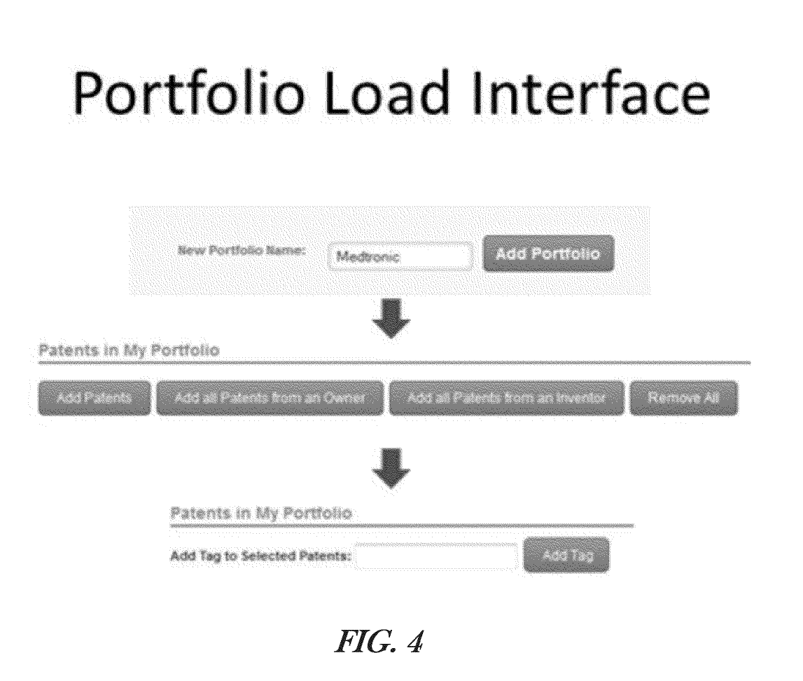

In certain example embodiments, a portfolio load interface is used to define a portfolio. FIG. 4 illustrates an example portfolio load interface, the portfolio load interface presents one or more input areas (e.g., text input fields, user selectable UI elements, etc.) When creating a portfolio, a user may enter a new portfolio name in a text input field and select (e.g., click on) the element “Add Portfolio” to request the patent portfolio management system to generate a portfolio. The user may select to add individual matters (e.g., patents, filed applications, unfiled applications, etc.) using the “Add Patents” UI element. The user may specify the matter(s) to be added to the portfolio by number, name, or any other identification method. Alternatively, the user may add all matters owned by a particular owner or assignee by selecting the “Add all Patents from and Owner” UI element. Upon selecting this UI element, the user may specify the name or any other identification of the owner whose matters are to populate the respective portfolio. Alternatively, a segment of a portfolio may be defined to include a slice of a particular portfolio (e.g., a subset of matters of the total number of patents/applications in a portfolio). In some example embodiments, a portfolio slice may include one or more matters in a particular technology class. Portfolio segments may be defined by a client's strategic business unit or may be provided as a functional ontology identified by the client. Upon the user making a selection with respect to the method of populating the portfolio, the portfolio management system may populate the generated portfolio based on the user's selection. The user may also create a portfolio that includes the patents and applications of a competitor.

As illustrated in FIG. 4, the portfolio load interface allows the user to remove one or more matters from a portfolio. For example, upon selecting a portfolio name, a user, based on the appropriate permissions, may remove all matters from a portfolio by selecting the “Remove All” UI element. The portfolio load interface also allows the user to tag one or more matters in a portfolio based on a law firm name, product, or any number of strategic reasons.

FIG. 5 illustrates a main portfolio interface used to present the matters in a portfolio, according to some example embodiments. As illustrated in FIG. 5, the matters may be displayed in a list of matters. For example, the user may select from a drop-down menu the “Medtronic” portfolio. Upon receiving an indication of the user's selection of portfolio name from the list of portfolio names displayed in the drop-down menu, the portfolio management system may display the results (e.g., the matters) corresponding to the selected portfolio name in the main portfolio UI.

The portfolio management system may allow the user to interact with one or more UIs to view comprehensive data that pertains to a patent asset or portfolio (e.g., boilerplate analytics), or to view only portions of data that the user is interested in at a particular time. As such, the user may designate what data is important to him by interacting with the various tools of the system using the system's UI(s). To receive only relevant data, the user may select to refine or filter the displayed results by using one or more UI elements, as discussed below. Upon receiving a request to apply a user-selected filter to a particular set of data (e.g., a portfolio), the system may selectively display a subset of the particular set of data based on the filter selected by the user. For example, if the user selects a UI element that says “show only issued patents”, the patent management system may only display data that corresponds to issued patents in the particular portfolio.

The list of matters may be displayed as a continuous list or may be split into pages. If the list of displayed matters is split into pages, the user may select one of the pages to view a portion of the list of matters. In addition to the list of matters, the main portfolio UI may, for example, display the total number of U.S. applications filed, total number of U.S. applications pending, total number of U.S. patents granted, and the date of the most recent publication. The displayed items may be grouped by category, such as “Publications/Patents in My Portfolio” or “Unpublished Applications in My Portfolio”.

The information displayed for each patent or application in the portfolio (or portfolio slice) may include a hyperlink (e.g., the publication/patent number) for each patent or application for obtaining additional information related to the particular patent or application. The additional information may be displayed in the same portion of the UI as the Main Portfolio information or in a separate section of the UI.

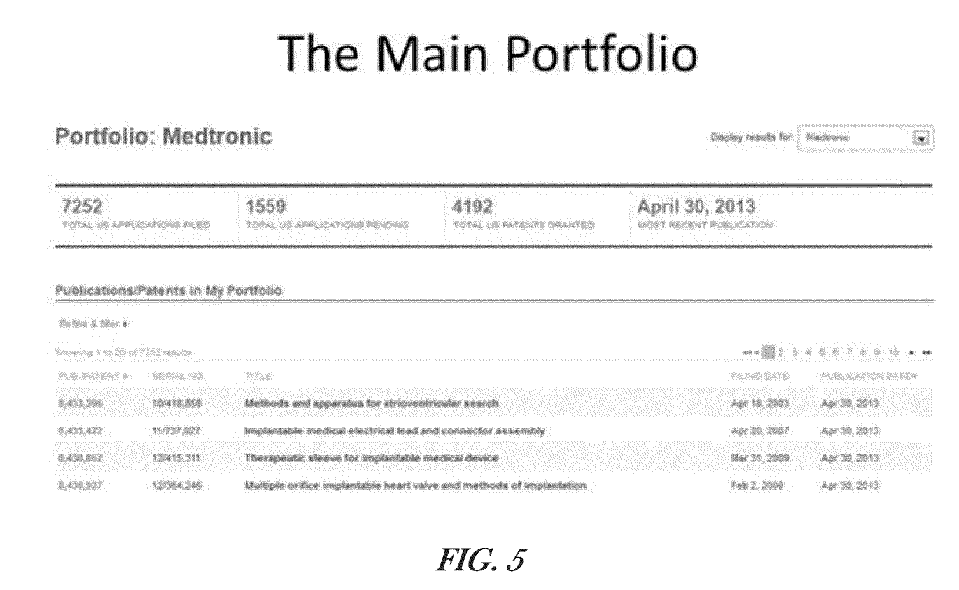

Upon the user selecting the down arrow button of the “Display results” drop-down menu, the portfolio management system may display a list of portfolios or portfolio slices, as shown in FIG. 6. The “Display results” drop-down menu, in certain example embodiments, also allows a user to select the portfolio of a competitor.

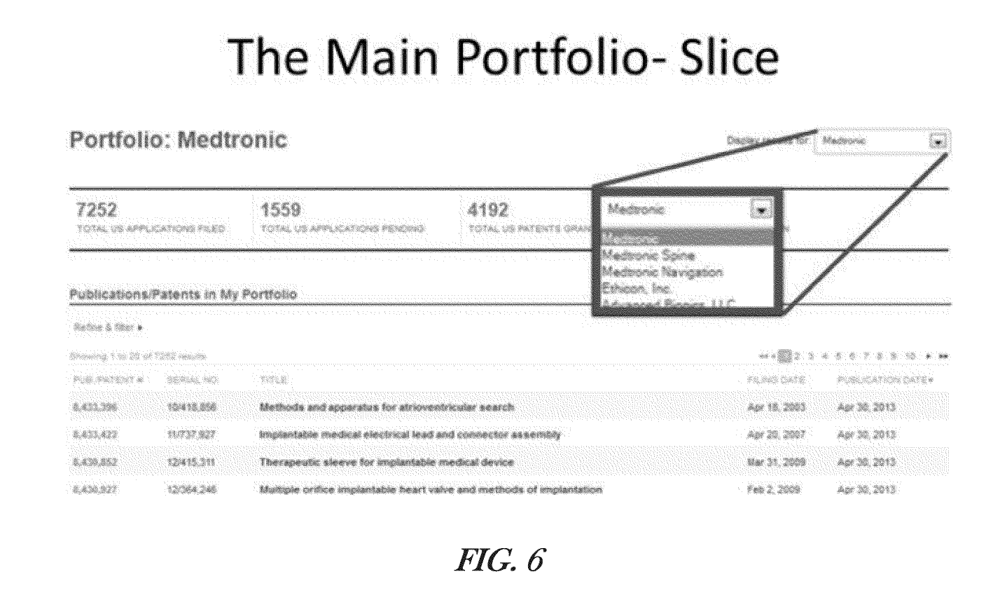

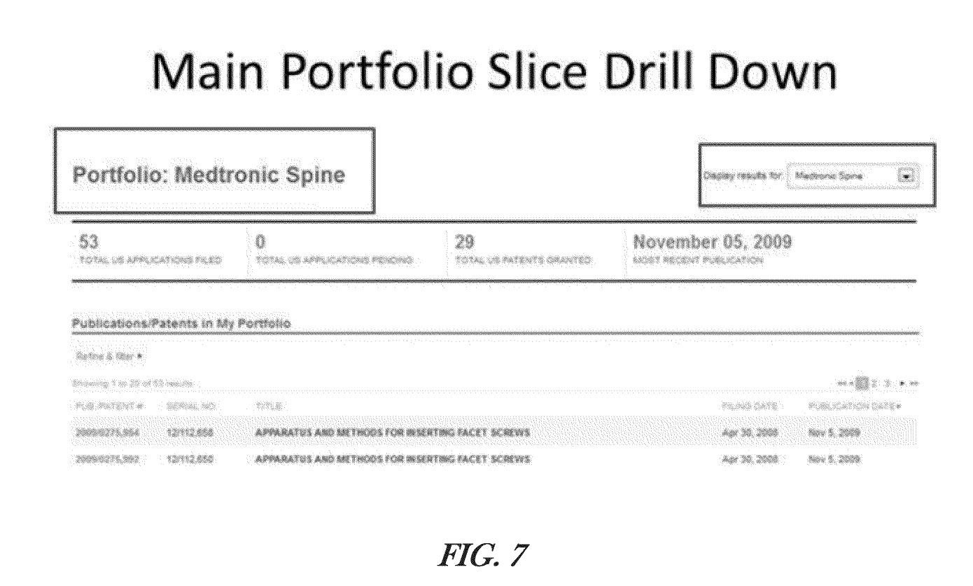

The user may then select, for example, the portfolio slice called “Medtronic Spine” from the list of displayed portfolio/portfolio slice names. Upon receiving an indication of the user's selection of a portfolio slice, the portfolio management system displays the matters included in the selected portfolio slice. In the example main portfolio UI illustrated in FIG. 7, the “Medtronic Spine” portfolio slice represents a subset of all the matters included in the “Medtronic” portfolio. In other words, the UI allows the user to refine or filter the matters displayed for further analysis according to one or more criteria. In this example, by selecting the “Medtronic Spine” portfolio slice, the user requested that the display of results be limited based on the particular portfolio slice name.

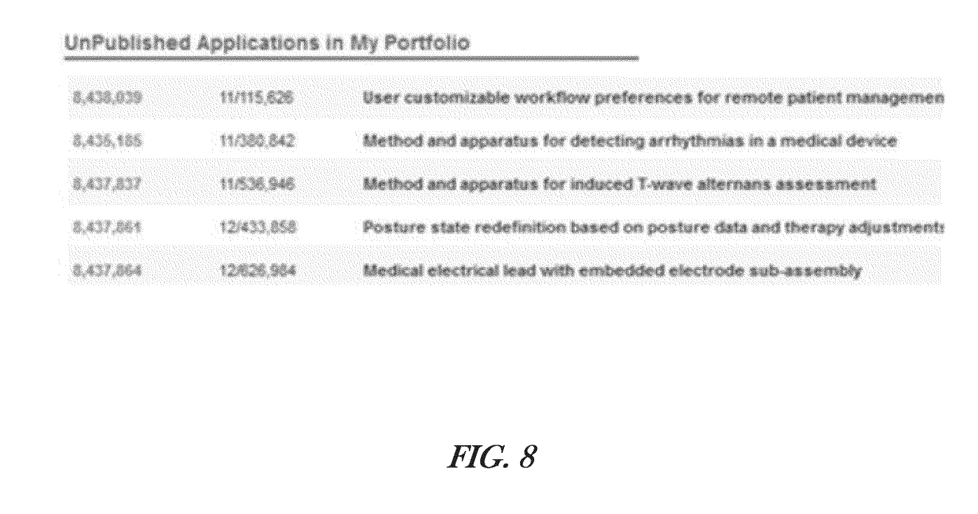

In another example, the user may limit the results displayed based on unpublished applications, as illustrated in FIG. 8. To illustrate this example, no actual unpublished information related to Medtronic Inc. was used.

FIG. 9 illustrates other examples of refining or filtering criteria. Upon receiving an indication of the user selected the “Refine & filter” UI element (e.g., a link), the portfolio management system may present the user with one or more selectable criteria/filters from which the user may choose which criteria to apply in filtering the portfolio data for further display. The user may refine the list of matters to be displayed by issue or publication date. In some example embodiments, the UI allows the user to specify a range of dates by presenting input fields where the user can input a start (e.g., a “from”) date and an end (e.g., “to”) date. In other example embodiments, the user may specify the issue or publication dates of the matters using a calendar tool included in the UI. The user may refine or filter the portfolio results by type of matter (e.g., patents, filed applications, unfiled applications, all matters, etc.), patent status (e.g., in force, expired, or all), class, title, inventor name, serial number, patent or publication number, abstract content, tag name (e.g., by law firm name or client-provided ontology). As illustrated in the UI below, the data presented may also be sorted based on filing date, publication date, publication number, or number of forward cites.

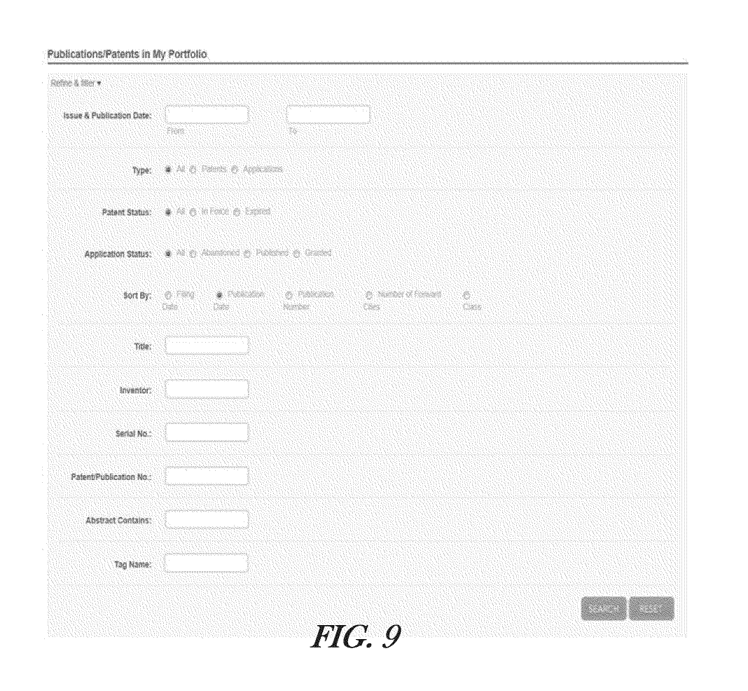

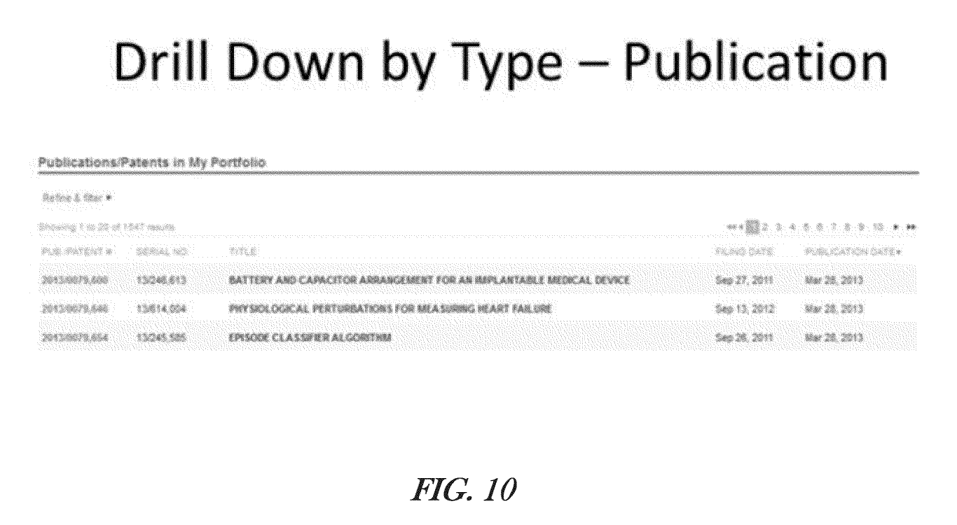

FIG. 10 depicts an example list of portfolio results filtered by publication date.

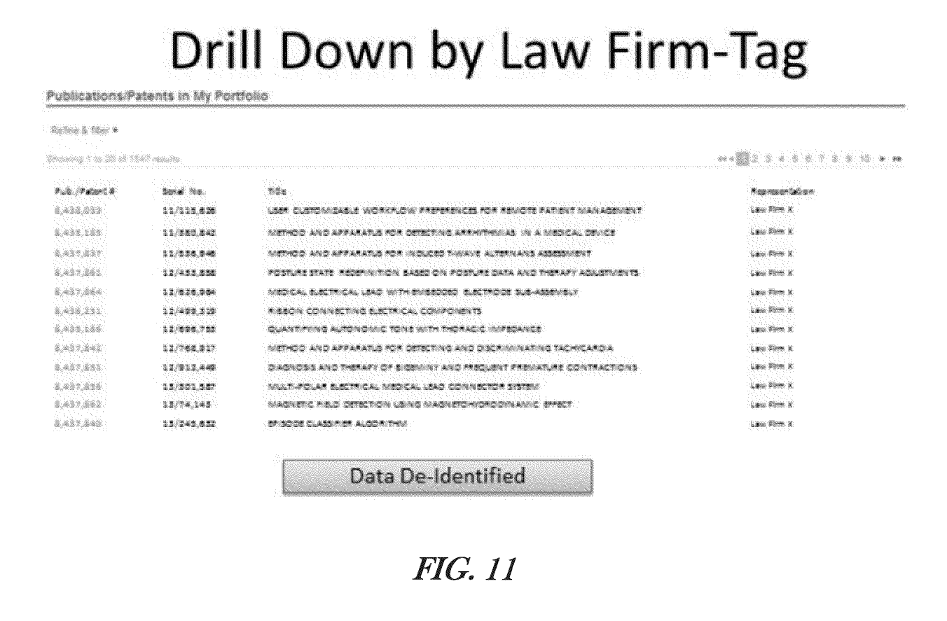

FIG. 11 illustrates an example list of portfolio results filtered by law firm tag. Similar to other illustrations herein, FIG. 11 contains de-identified data.

The UI allows a user to drill down to the details of a particular matter (e.g., drill down from the portfolio level to the details at the patent level) by either specifying the number of the matter, as discussed above, or by selecting a particular matter from the list of matters included in a portfolio displayed in the UI by the portfolio management system. FIG. 12 depicts a detail of the main portfolio UI including a rectangle surrounding U.S. Patent Application No 2008/0208,020 to highlight the user's selection of this application.

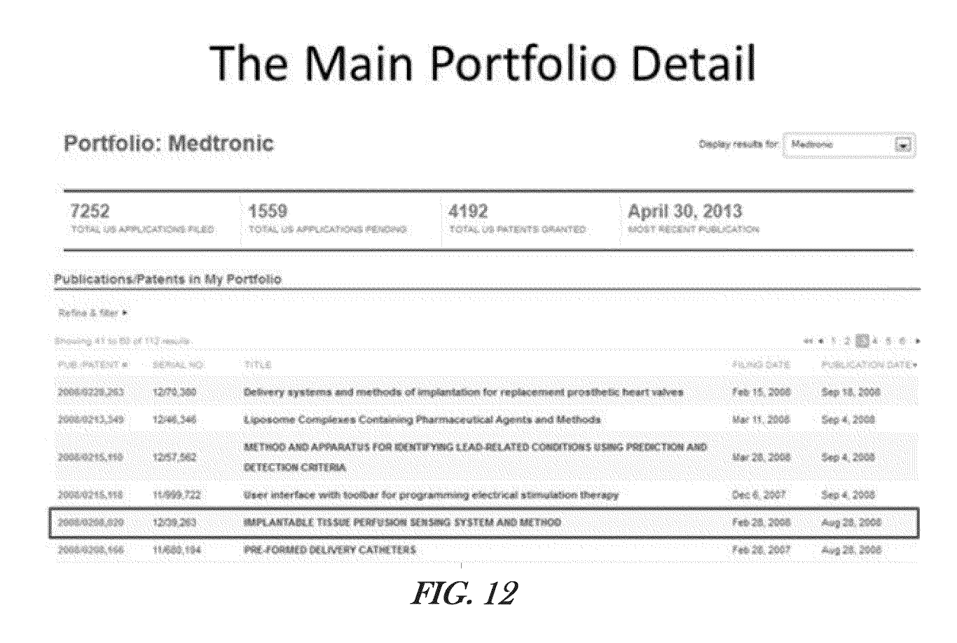

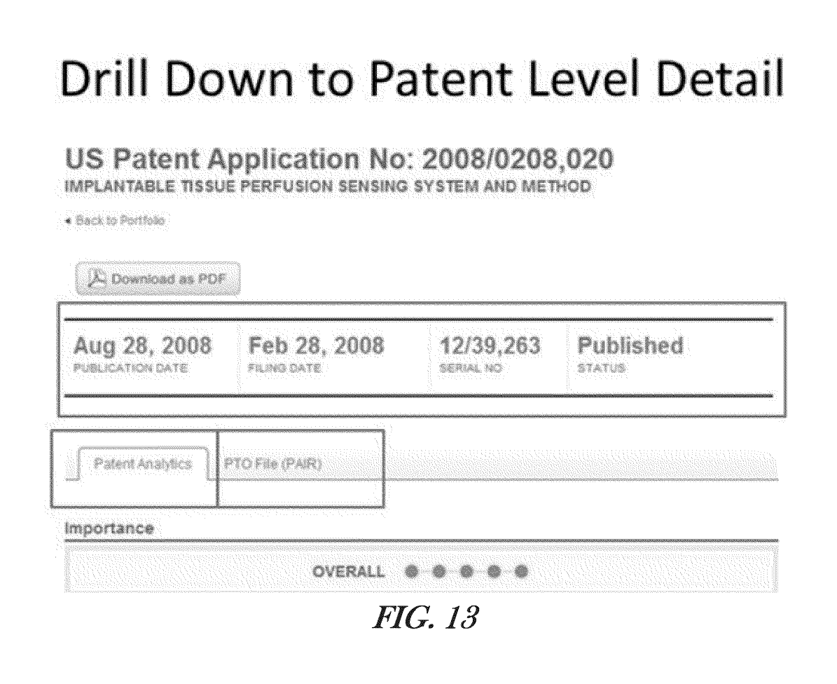

Upon receiving an indication of the user's selection of U.S. Patent Application No 2008/0208,020, the portfolio management system displays additional details for the respective application, as illustrated in FIG. 13. The additional information pertaining to the particular patent or application displayed to the user may include a “Download as PDF” selection element allowing a user to request downloading of the patent or application in PDF form, the issued date if a granted patent, the filing date, the serial number, and the status of the patent or application.

The user may further be allowed to select between patent analytics provided for the particular patent or application, or the PTO File (PAIR) data. The UI illustrates some of the functionality of the patent management system that allows the user to identify at which stage the particular patent is in the prosecution process, and to access PAIR data, portfolio data, and portfolio analytics all in one place.

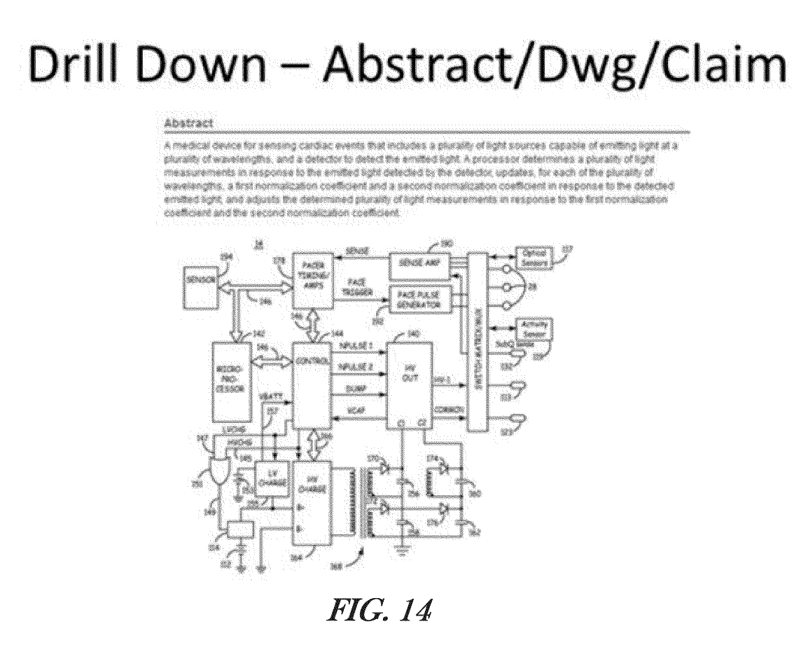

As depicted in FIG. 14, for a matter selected by the user, the portfolio management system may display in the UI the abstract of the matter, the first (or primary) drawing from the matter, or the first claim, or a combination thereof. The display of the abstract, first claim, or drawing may allow the user to understand the scope of the matter in the broadest sense.

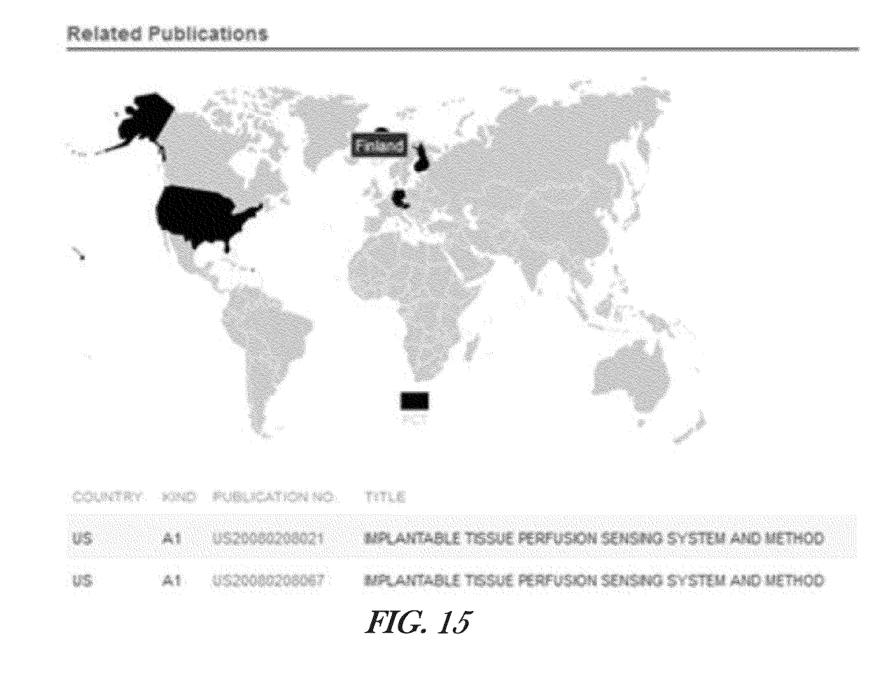

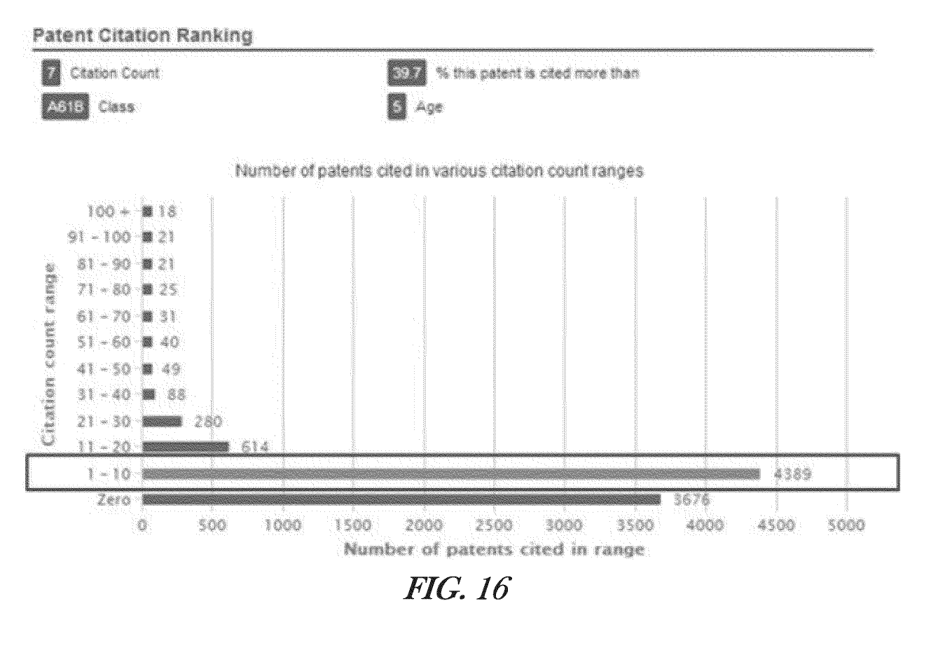

In some example embodiments, the patent analytics are displayed by default in response to a user selecting a matter (to obtain patent level details). As part of the patent level analytics, the patent portfolio system may display a metric that measures the importance of the particular portfolio item. The importance of the respective patent or application may be determined based on the size of the US family of patents and/or applications, the international coverage, the patent longevity, the forward citations, or a combination thereof. Also as part of the patent level analytics, the portfolio management system may display:
1) related applications (e.g., the family information of the respective patent/application). As illustrated in FIG. 15, the family information may be presented using a map of the world that indicates in which countries patent have issued or applications have been filed. The family information may also be displayed as part of a list. Each item in the list may be a matter identified by, for example, a publication number, a country, a kind, a title, etc.
2) the name of the patent owner;
3) the international classification;
4) the inventor's name;
5) the cited art displayed as a list of patents and applications;
6) the cited art displayed as a graph illustrating which patent owner's patent or application was cited, in what year, and the number of counts of cited art of a particular owner was cited in a particular year. This displaying of citations analysis allows a user to understand what art may have been considered relevant by the Examiners at any particular time during the prosecution of the respective patent or application;
7) the patent citation ranking (to illustrate how the respective patent compares to other cited patents) based on the citation count, technology class/category, percentage this patent is cited more than its counterparts, or age of patent, as shown in FIG. 16;
8) forward cites;
9) maintenance fees, including due dates and fees, and late payment grace periods and surcharges;
10) any added tags;
11) other patents or applications by the owner of the respective patent or application; and
12) other resources, such as a link that allows the user to view the respective patent or application on an external website (e.g., Google Patents).

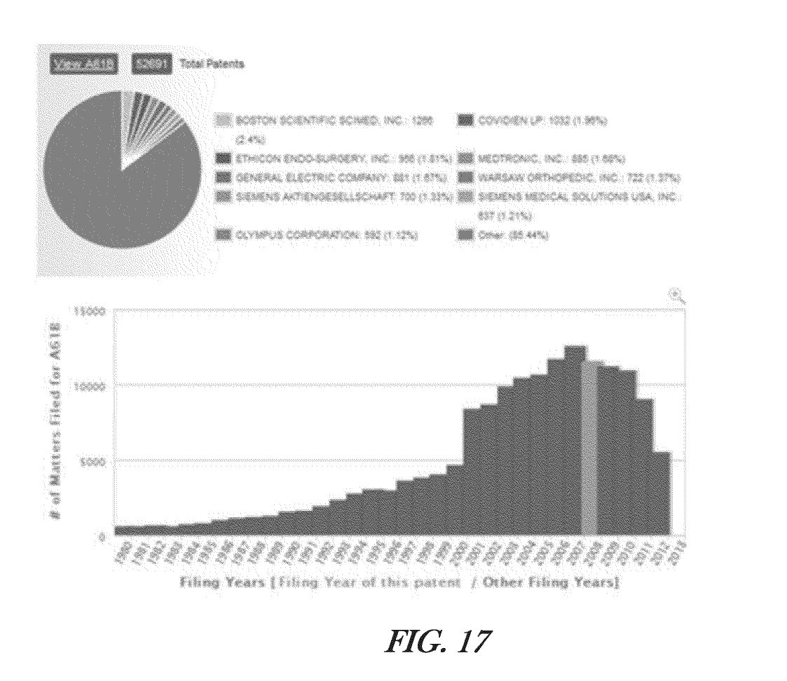

In some example embodiments, the relevance of the patent may be illustrated using one or more graphs displayed in a UI that provides details for a particular patent. For example, a graph (e.g., a pie chart) of the distribution of the total number of patents among the patent owners in a class (a user may determine who the top assignees in the class) may be displayed in the UI, as shown in the illustration below. In another example, as shown in FIG. 17, a graph may indicate priority dates (e.g., the filing years during which patents of the particular classification were filed, the number of patents filed per year, and an indication of the year when the respective patent or application was filed. This may be useful for monetization or licensing of patents because it helps the user understand the position of the respective patent in relation to other patents in the classification.

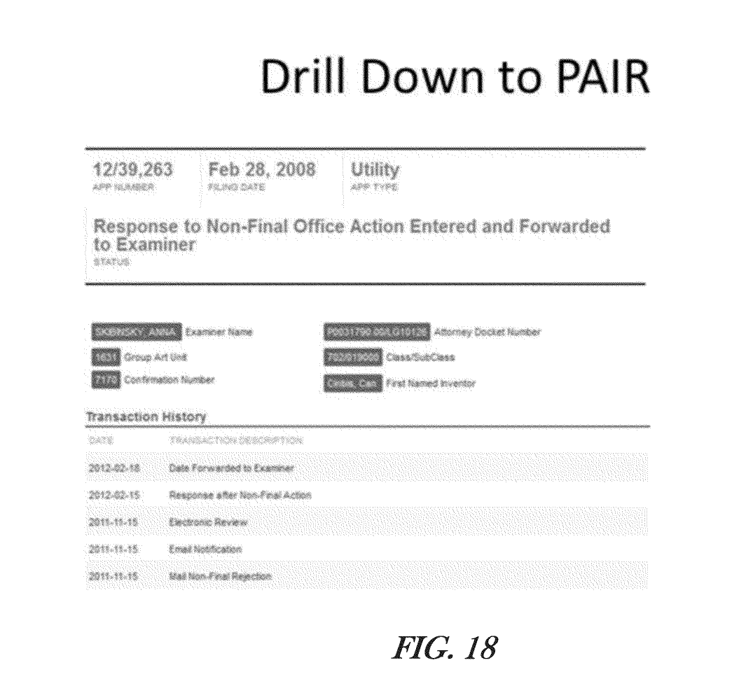

Upon receiving an indication of the user selecting to view the PTO file, the system displays PAIR data. As discussed above, the patent management system and its UIs may allow a user to access a variety of internal patent data (e.g., docketing information), external data (e.g., PAIR information), and patent and patent portfolio analytics from one place. As illustrated in FIG. 18, a user may obtain information that identifies the particular patent or application (e.g., application number, filing date, type, etc.) and the response level from the examining office. Examples of other data that may be displayed in a drill down to PAIR data are information that identifies the examiner, the art unit, confirmation number, attorney docket number, class/subclass, first named inventor and a list of transaction history items, each item including a date the transaction occurred and a transaction description.

In some example embodiments, the UI displays high level analytics of a portfolio. High level analytics provide a layered-level look of the portfolio as the user examines a portfolio of the user's company, a portfolio slice, or a competitor's portfolio/portfolio slice.

Under the Details section, the UI displays a list of statistics for the portfolio/portfolio slice. One such statistic is the total citation count. Because the total citation count of a portfolio may indicate how rich and robust the portfolio is, this statistic allows a user to quickly and better understand the depth of a particular portfolio. Other statistics that may be presented to the user under the Details section are the Expired assets count and the Abandoned assets count.

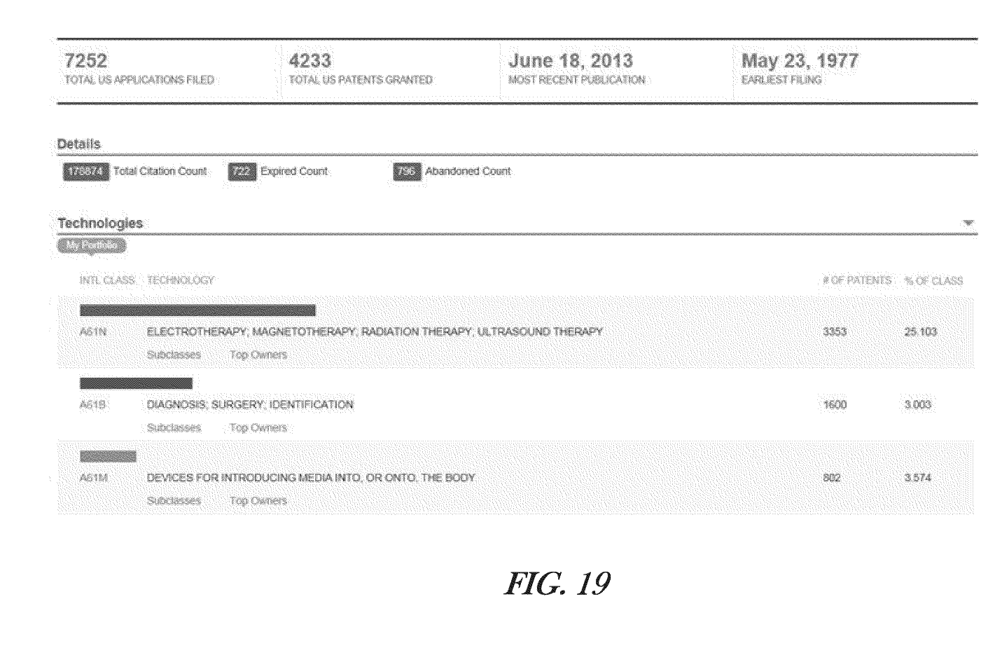

Under the Technologies section, a list of classifications for the assets in the portfolio is displayed, as illustrated in FIG. 19.

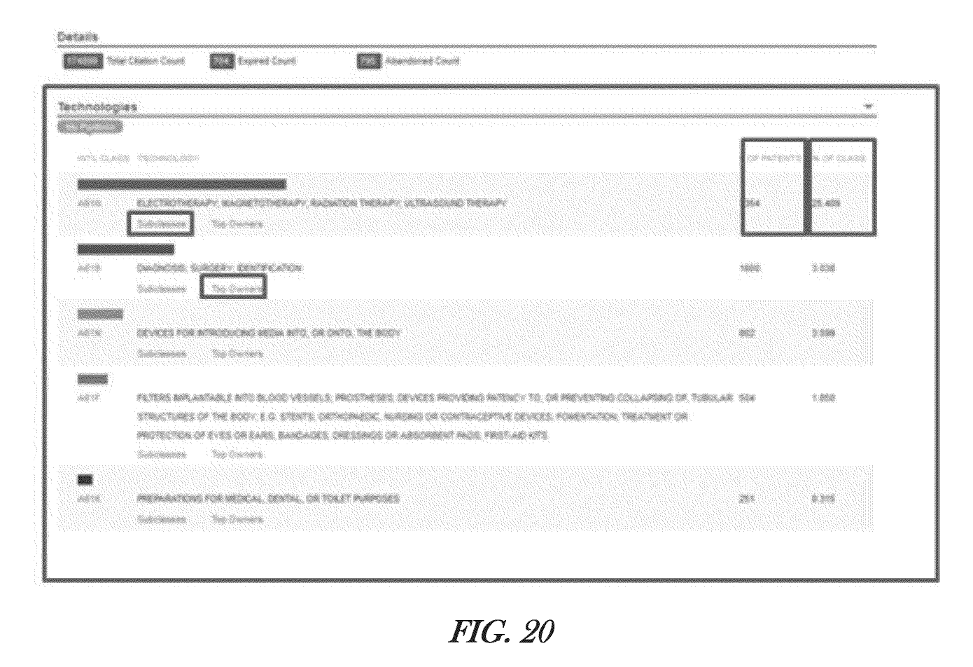

For each classification, the patent portfolio management system displays the number of patents the owner has that are part of the particular classification and their percentage of the classification as a whole. Each class may be displayed as subdivided into subclasses or by top owners, as illustrated in FIG. 20.

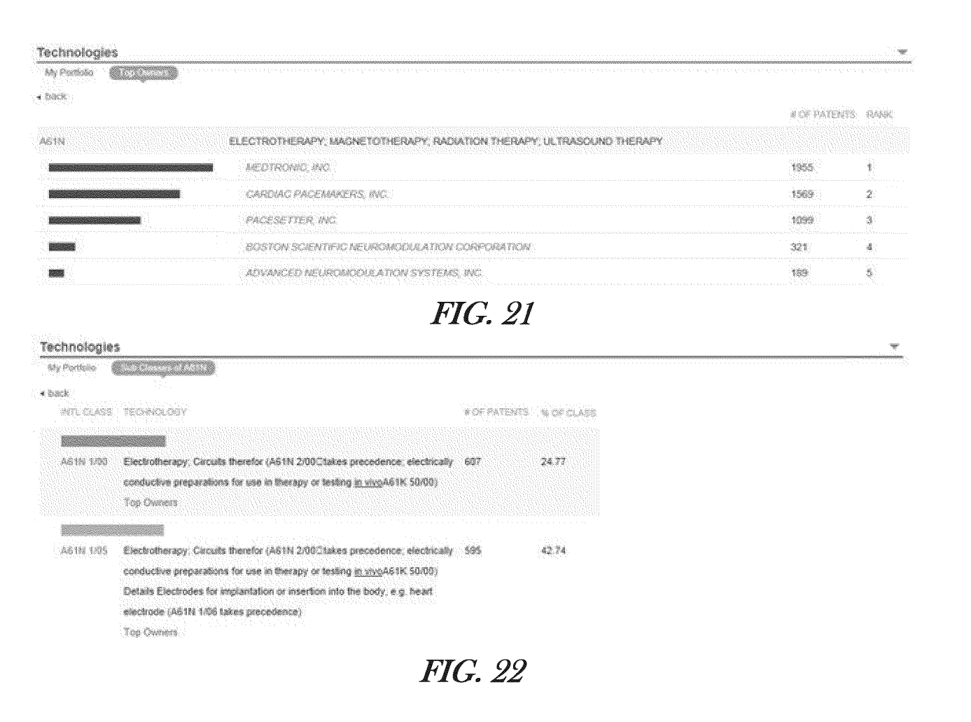

As discussed above, a user may drill down into each category by selecting the subcategory link or the top owners link. For example, upon receiving an indication that the user selected the top owners link, the portfolio management system may display the list of top owners for that particular category, as shown in FIG. 21. The UI shows, for each owner, the number of patents owned and the owner's rank in the particular technology class as compared to other owners in the respective technology class.

Similarly, as shown in FIG. 22, a user can drill down from a class to a subclass to view how many patents/applications an owner has in a particular subclass and what percentage of the total patents/applications in the subclass the particular owner's patents/applications have. Also, by selecting the Top Owners link for a particular subclass, the user may be presented with the list of top owners in the respective subclass of patents/applications, as shown in FIG. 21. The ability to view classifications, subclasses, and top owners using the same UI may, for example, be helpful to a user in matching classifications with products/product lines or in performing competitive analysis.

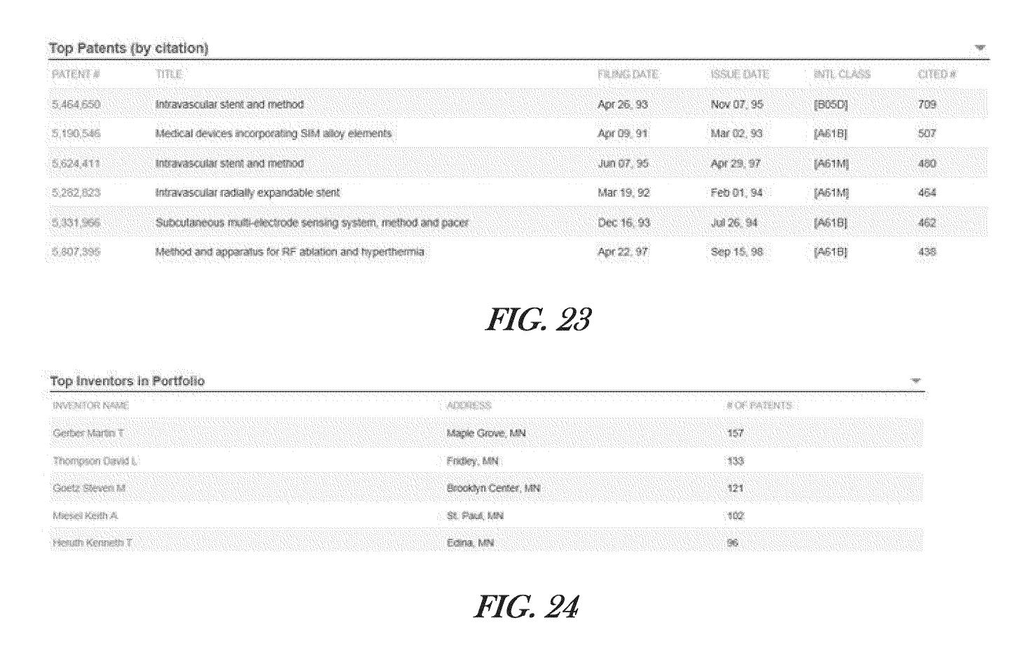

As illustrated in FIG. 23, the high level analytics portion of the UI may also display the top cites by portfolio (e.g., the portfolio patents cited the most). The most cited patents in a portfolio may be presented in a list. Each entry in the list identifies a particular top cited patent by patent number, title, and filing date. The UI also displays, for each listed top cited patent, the issue date, the classification, and the citation count. The number of citations of a patent may be an indication of the patent's value to an organization. In other words, if a patent is highly cited, the patent may have a higher value in the portfolio as compared to other patents in the portfolio.

The high level analytics portion of the UI may also display the top inventors by portfolio. As illustrated in FIG. 24, the high level analytics UI may rank the inventors by number of patents. The UI may also list each inventor's address. A user may identify Research and Development (R&D) centers based on inventor addresses. The user may also identify who the top contributors are to the product line of an organization.

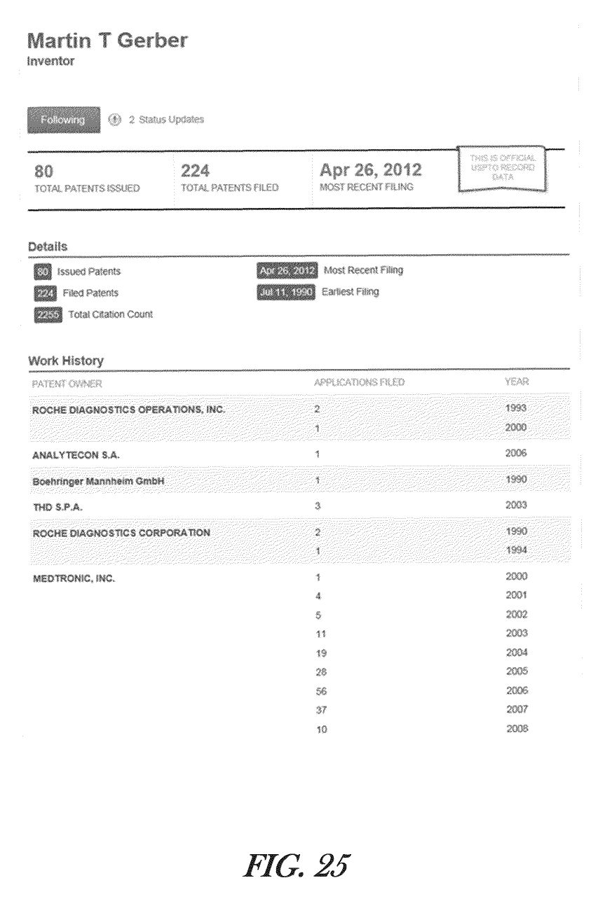

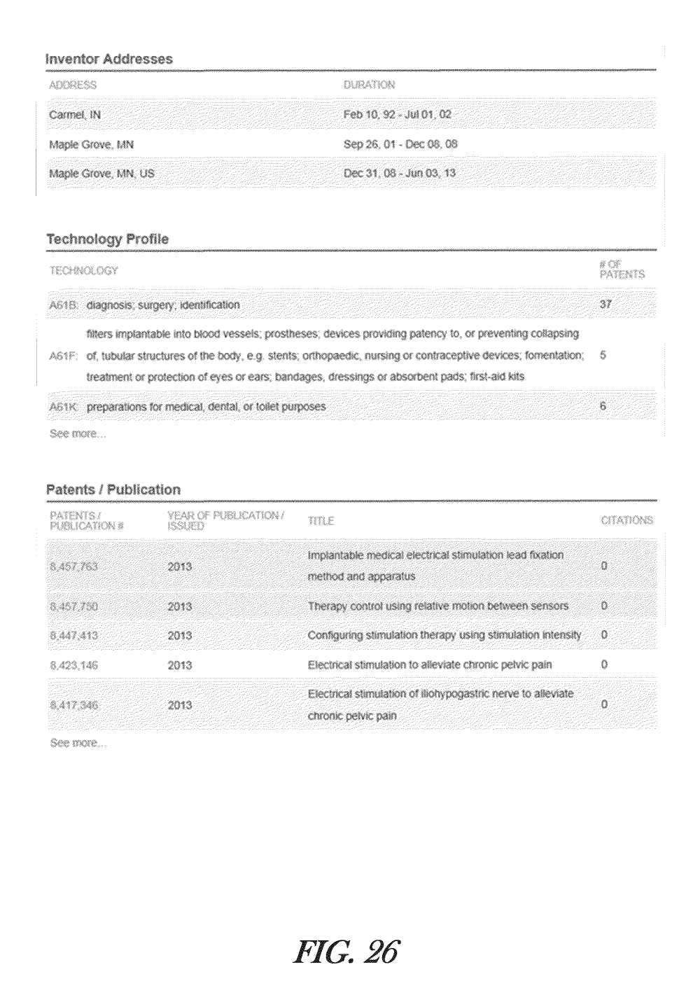

By receiving an indication that the user selected (e.g., clicked on) a link representing the name of a top inventor, the portfolio management system may display additional information for the particular inventor, as illustrated in FIGS. 25 and 26. The patent portfolio management system may display a list of patents/applications by the particular inventor and additional information for each patent, such as year of issue or publication, a title, and a citation count. The system may also display a list of technology classifications in which the inventor has patents and the number of patents by the respective inventor for each technology classification, as well as the current/prior address of the inventor. Based on the inventor's prior patent assignment, the system may display the inventor's work history (e.g., prior employers of the inventor). From the position of an in-house counsel, the system is a very useful tool to keep track of inventors who may leave the employ of the portfolio owner. It is also beneficial to in-house counsel to know where their inventors take new jobs for the purpose of protecting the intellectual property of their organization.

In some example embodiments, the patent management system allows a user to select to “follow” a particular inventor by selecting the “Following” element of the UI. This allows the user to set up a watch for activities by inventor, as illustrated in FIG. 25. The user may request a notification of changes in status related to the particular inventor. Examples of changes in status may be a new invention, the publication of an application by the inventor, the granting of a patent of the inventor, or the inventor changing jobs.

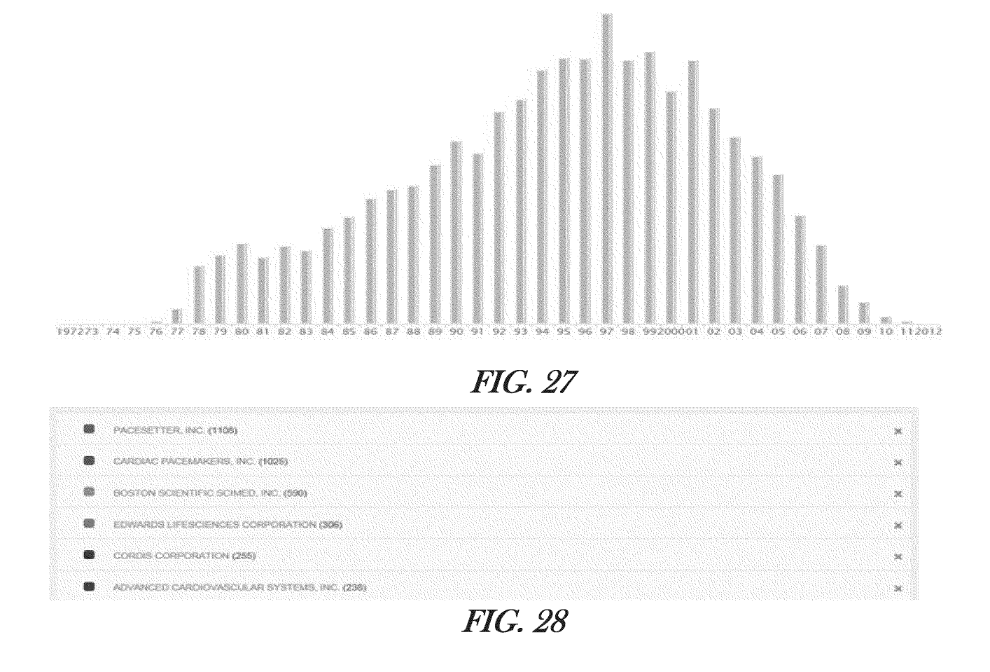

The patent portfolio management system may also display in the UI high level citations including backward citations and forward citations. Backward citation allows a user of the UI to view the art cited against a patent/portfolio, trends related to priority, what references were cited during the prosecution process, and self citation. Forward citation allows a user of the UI to see who the other owners are in a particular market, who cited the patents/applications of an organization, and self citation. The backward citation and forward citation information is useful for monetization, competitive analysis, and acquisition purposes. The backward citation and forward citation information may be presented graphically or numerically (e.g., by the numbers), as illustrated in FIGS. 27 and 28. The citation information is presented in a manner that allows a user to easily incorporate the presented data into other reports that a user may want to create.

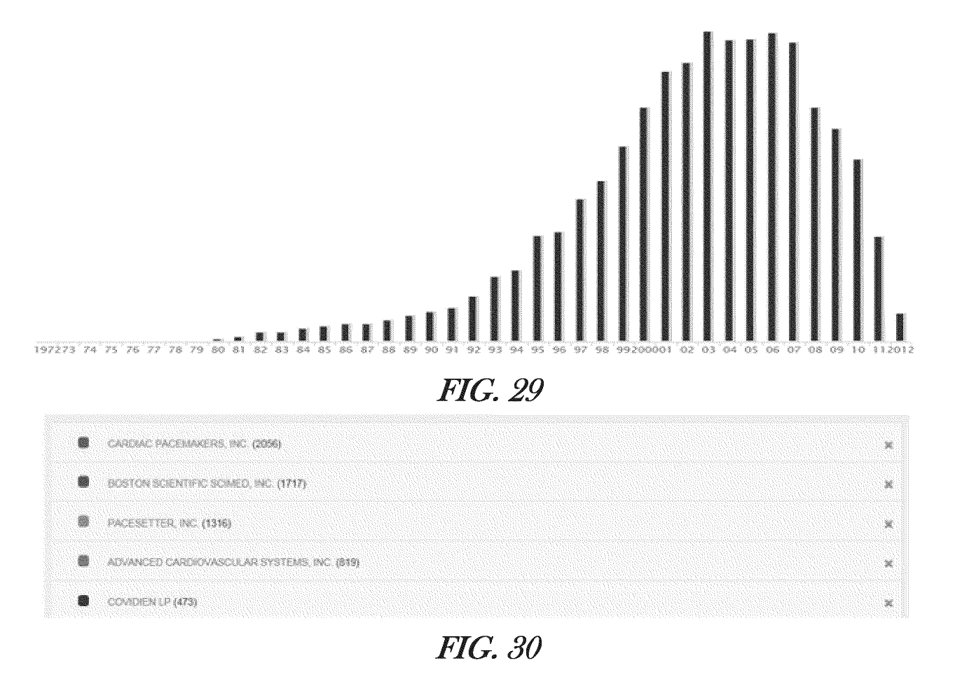

FIGS. 29 and 30 show forward citations graphically and numerically. By selecting the “x” corresponding to an entry in the numerical representation of the forward citations, the portfolio management system may exclude the self citations from the citation analytics (e.g., from the count of forward citations) presented to a user. As such, the user may view all the citation analytics excluding the self citations.

The portfolio management system (e.g., the high level analytics tool of the portfolio management system) may present prosecution metrics in a prosecution metrics UI. The prosecution metrics UI allows the user to obtain a statistical analysis of the status of prosecution at the portfolio level (e.g., the portfolio's state of affairs based on all of its assets) at a point in time. The prosecution metrics may be presented in a prosecution summary, as shown in FIG. 31.

The prosecution summary may include information about (e.g., the count of) the matters that are pending awaiting prosecution, pending in prosecution, pending under appeal, or currently allowed. The prosecution summary may also display prosecution metrics such as
1) the count of matters in prosecution by number of office actions received,
2) the count of matters by number of responses filed and case interviews filed,
3) the percentage of time a response leads to allowance (e.g., last twelve months),
4) the count of pending matters by number of RCE(s) filed
5) allowance by number of office action responses filed (e.g., last twelve months), or
6) the number of pending matters with restriction requirements.

FIG. 32 illustrates a graphic representation of the count of matters in prosecution by the number of office actions received.

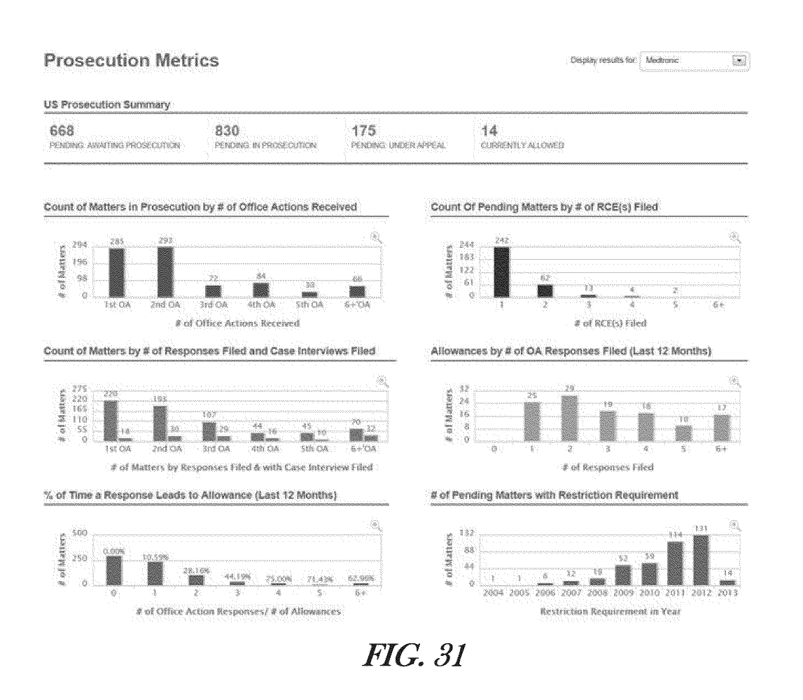

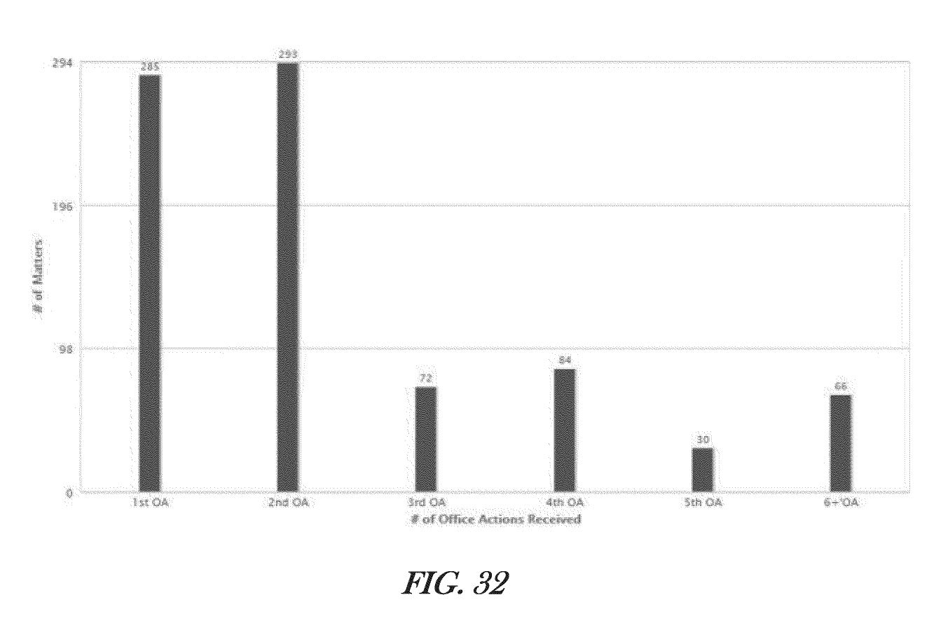

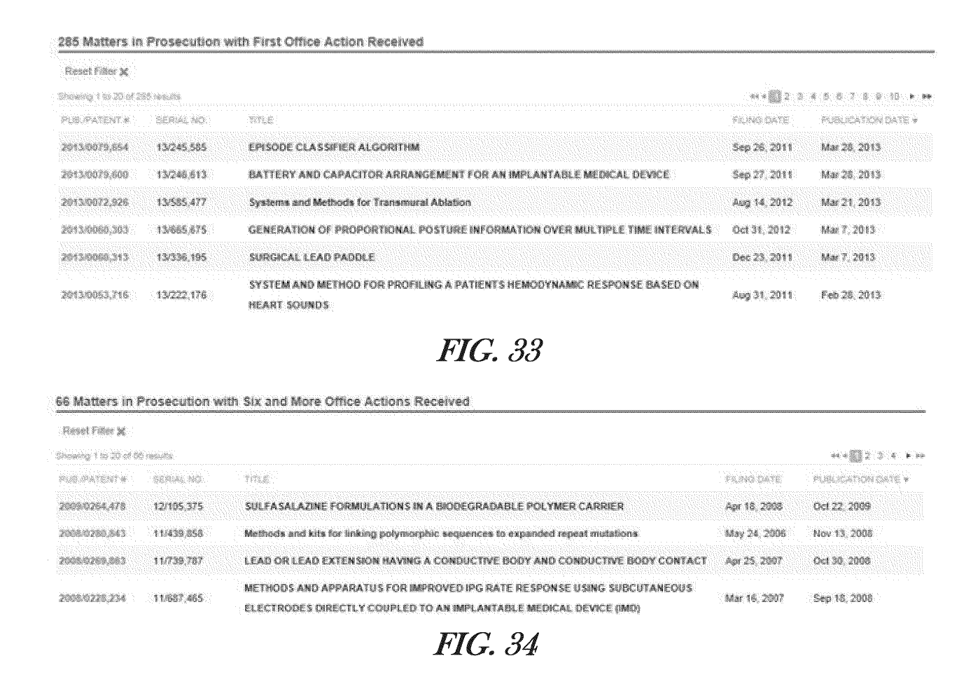

Upon receiving an indication that the user selected one of the columns representing the number of matters grouped by a particular number office action, the portfolio management system may display a list of the matters in the corresponding group of matters. For example, if the user clicks on the leftmost column representing the matters that are at the stage of the first office action, the portfolio management system may display the corresponding matters by the numbers, as shown in FIG. 33.

Similarly, in response to the user selecting to view the matters that have received six or more office actions (e.g., by clicking on the rightmost column marked “6+OA” to represent matters with six or more office actions), the portfolio management system may display a list of the corresponding matters, as illustrated in FIG. 34. The ability to identify, group, and present all the applications with a particular (e.g., high) number of office actions or RCE(s) received may be helpful to a user in understanding whether the respective applications are of increased value to the owner or are “stuck” applications (e.g., applications that have not been allowed after a pre-determined number of office actions).

The prosecution metric that shows a graph of the number of responses filed in response to a particular number office action and the number of case interviews filed may indicate the success of the office action responses in cases that had examiner interviews based on the particular office action, as illustrated in FIG. 35.

Upon receiving an indication of the user selecting a particular column representing a number of applications in the graph, the system may display the corresponding list of applications by the numbers, as shown in FIG. 36.

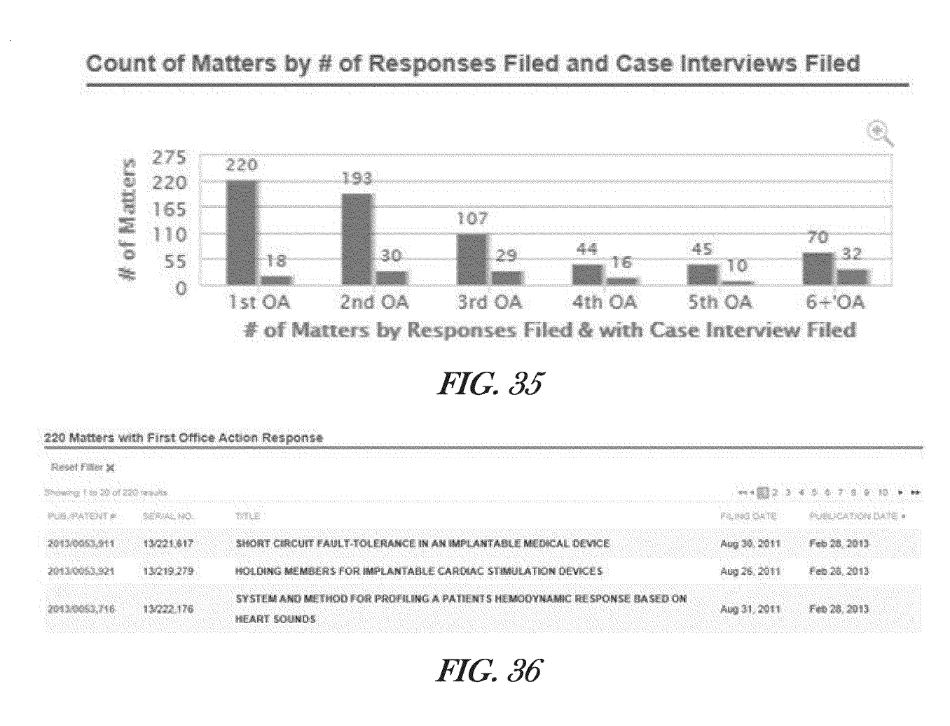

The prosecution metrics tool may display in the UI a graph of successful office action responses grouped by the number of responses filed, as illustrated in FIG. 37. For example, in this case, there were no matters that were allowed before a first office action. However, after a first office action, twenty-five matters received notices of allowance.

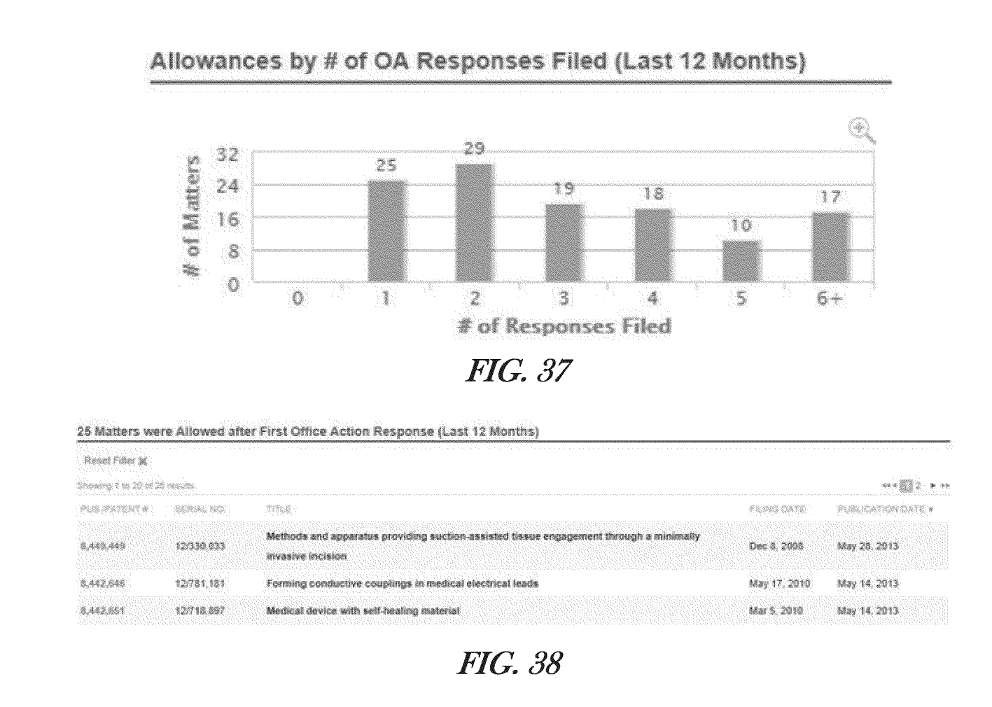

By selecting, for example, the column that corresponds to one office action, the user may view the patents/applications allowed after the first office action, as shown in FIG. 38.

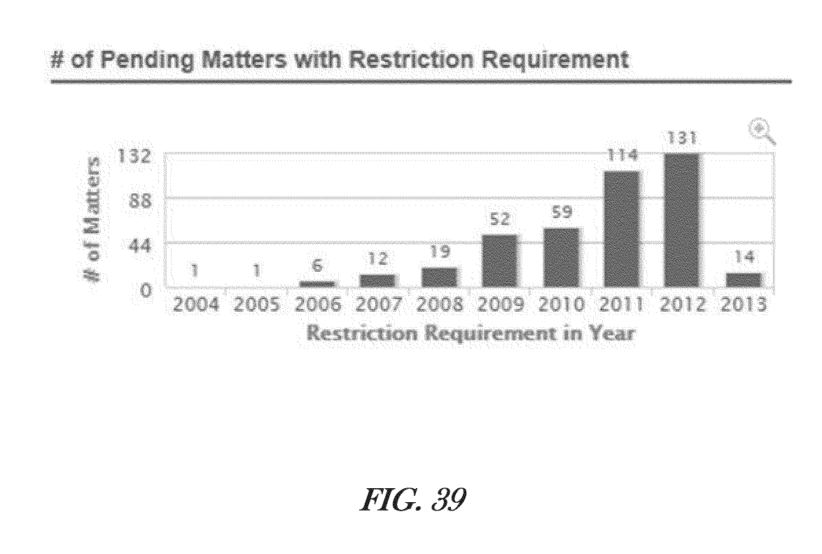

Another prosecution metric that may displayed in the prosecution summary UI is the restriction requirement metric. As illustrated in FIG. 39, the number of matters that received restriction requirements is graphically displayed by year. This graphical representation may also illustrate a trend toward more restriction requirements being issued in recent years.

Other prosecution metrics that may be displayed in the UI (e.g., in the prosecution summary section of the UI) may be time metrics that display the time between disclosure of the invention and the assignment, the time between the assignment and the filing of the application, and total time from the disclosure to the granting of the patent. In addition to time metrics, the portfolio management system may provide efficiency metrics that measure the efficiency (or inefficiency) of various actors during the patent prosecution process, such as patent examiners, art units, or law firms. The portfolio management system may also provide additional tools such as financial calculators (e.g., to calculate flat rate pricings for law firms).

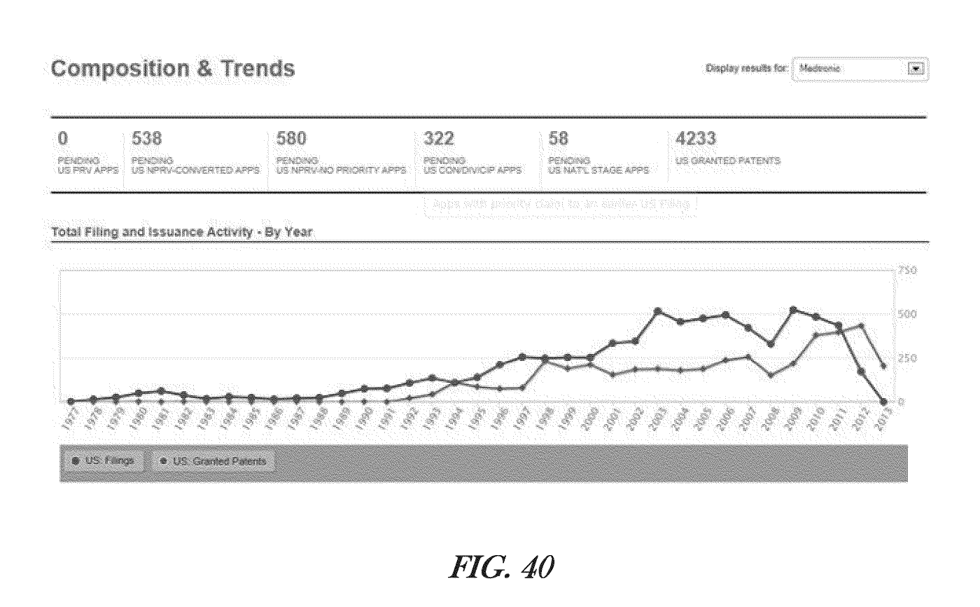

In some example embodiments, the portfolio management system includes a tool for determining portfolio composition trends. The portfolio composition trends may be displayed in a line graph in a portfolio composition section of the UI, as illustrated below. This area of the UI shows the composition of the portfolio over time. Tags may be added or removed, as necessary. For example, as illustrated in FIG. 40, one graph shows the number of filed applications by year, and another graph shows the number of issued applications by year.

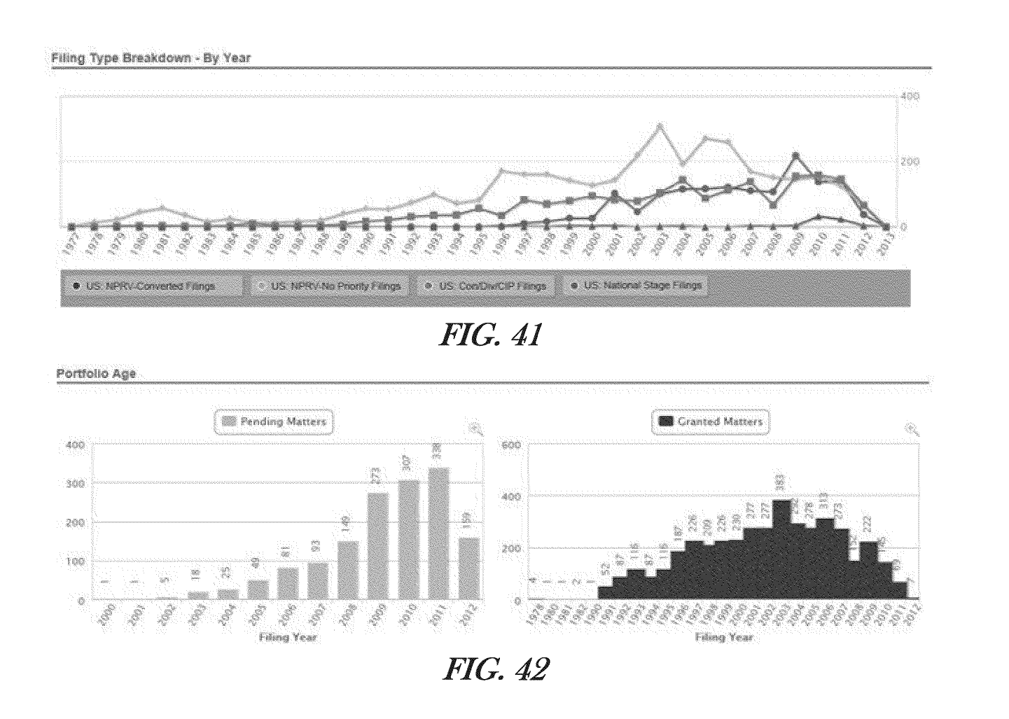

The graphs illustrated in FIG. 41 indicate the number of different types of filings, such as U.S. non-provisional converted filings, U.S. non-provisional no priority filings, U.S. continuation/divisional/continuation-in-part (CIP) filings, or U.S. National stage filings.

Also shown are graphs indicating the age of the pending matters and the age of the granted matters, as illustrated FIG. 42. A user may find these graphs helpful in understanding organizational efficiencies, for example, for purposes of acquisitions and divestitures of assets in a portfolio.

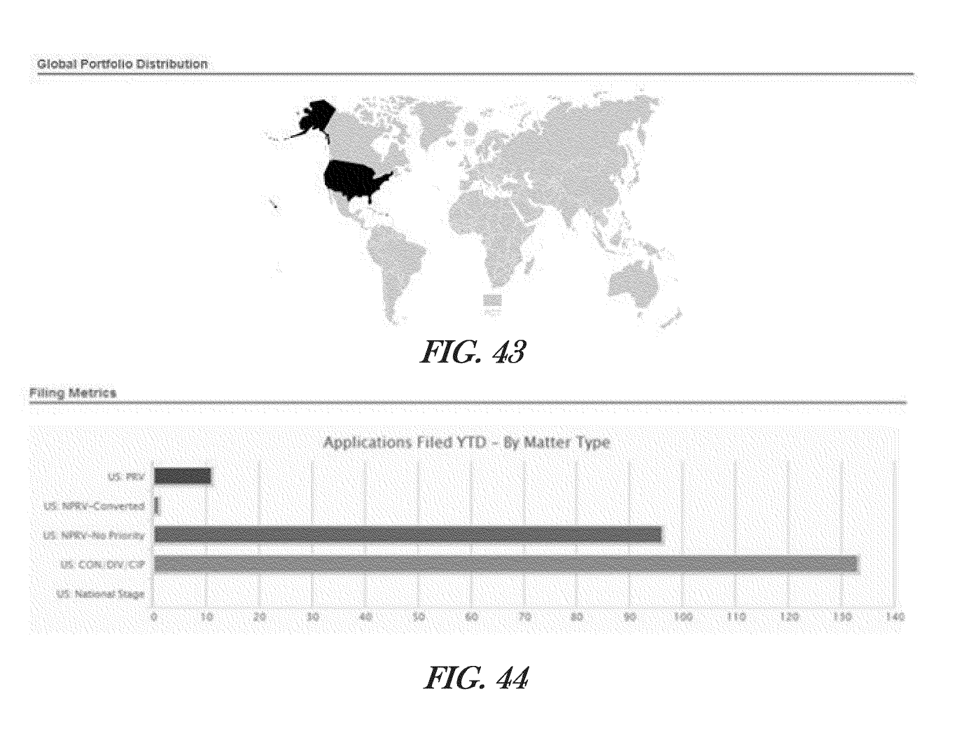

A map tool of the portfolio management system may illustrate, as shown in FIG. 43, the global distribution of the portfolio by, for example, highlighting the countries in which patents have been obtained or applications have been filed. By selecting a map area that corresponds to a particular country, the user may request that the system display information about the patent assets available (e.g., filed) in the selected country. In response to the user's request, the system may, for example, list the patents issued/application filed in the respective country (and relevant analytics discussed above).

A tool of the portfolio management system may generate year to date metrics to be displayed in a year to date section of the UI. As shown in FIG. 44, the year to date metrics may comprise data about applications filed year to date, such as the number of U.S. provisional applications, U.S. non-provisional converted applications, U.S. non-provisional no-priority applications, U.S. continuation/divisional/CIP applications, U.S. National Stage applications.

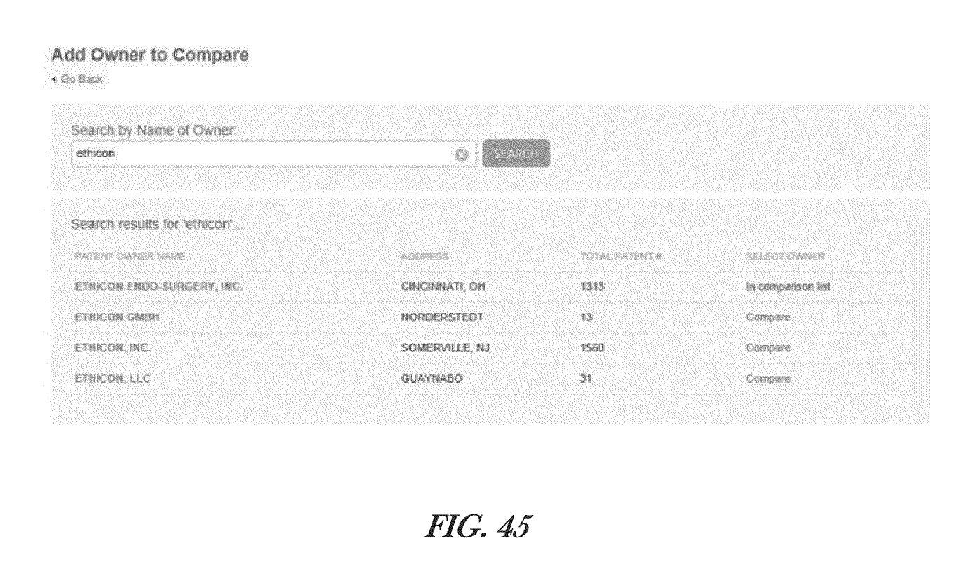

As illustrated in FIG. 45, the year to date metrics may include data about various prosecution metrics, such as the number of RCE(s) filed, the number of appeals filed, the number of U.S. patents granted, or the number of abandoned U.S. applications. The patent portfolio management system is not limited to generating metrics for the U.S. patent assets in a portfolio, but may generate metrics for any patent asset in a portfolio, including those filed/granted in other countries.

In some example embodiments, the patent portfolio management system may compare patent portfolios of two or more owners. A user of portfolio management system, using the UI section for comparing portfolios (shown in FIG. 45), may add the name of an owner whose portfolio may be used to generate a comparison to another (selected) portfolio. In some example embodiments, the user may identify the owner's name to be added to the comparison list by doing a search for the respective name (as shown in FIG. 45).

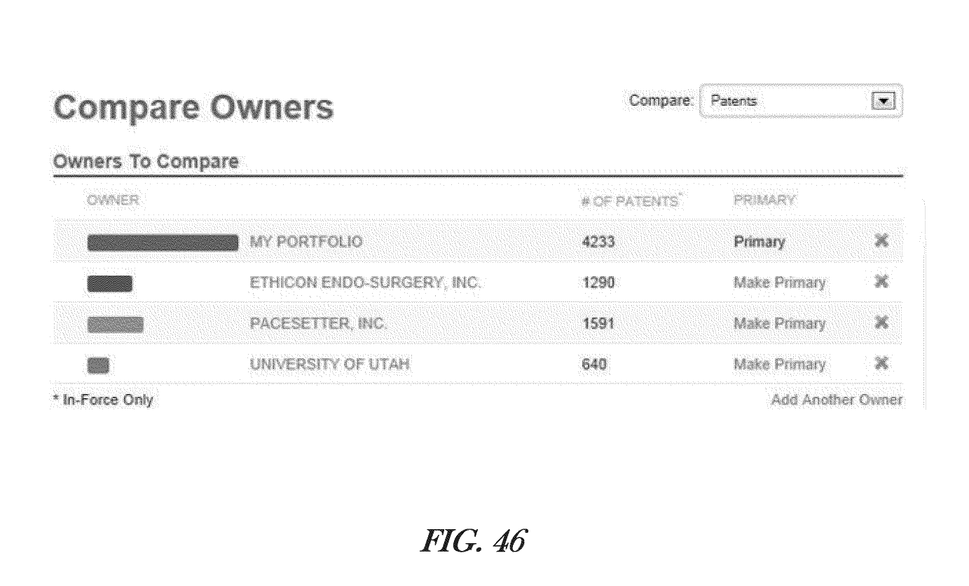

Upon receiving an indication of the user's selection of an owner's name to be added to the comparison list, the patent management system may display the comparison list in a UI section for comparing owners, as illustrated in FIG. 46. The comparison list displays a number of portfolio owners' names, a graphic indication of each owner's portfolio position in the market based on the number of patent assets owned, the number of patents/applications for each listed owner, and whether the respective owner's portfolio is the primary portfolio against which the other listed portfolios may be compared.

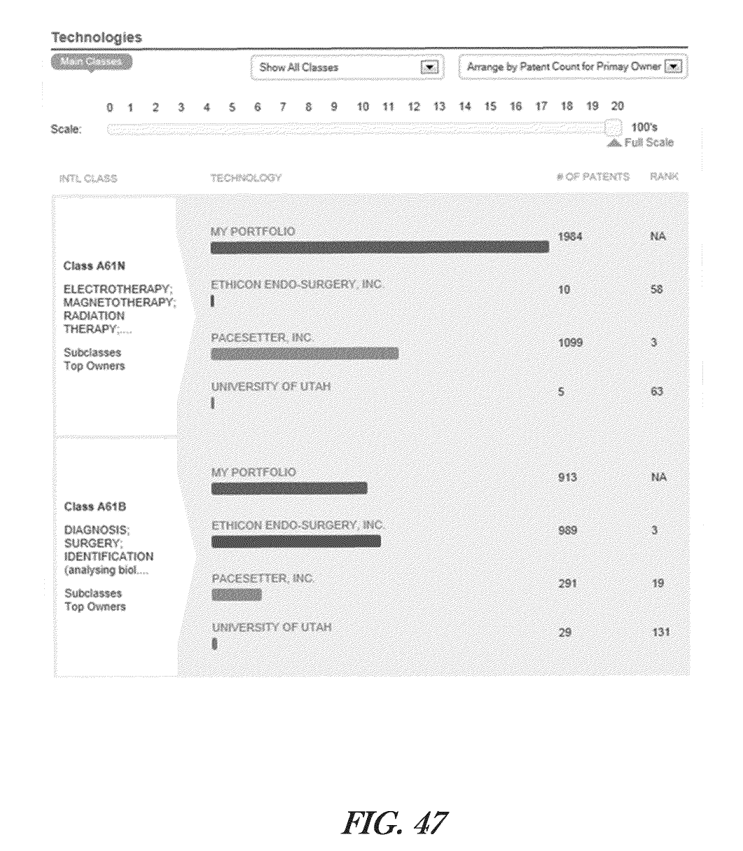

The comparison of two or more portfolios (or portfolio slices) may be done by classification codes, as shown in FIG. 47. The comparison results also include the number of patents each compared portfolio has in the particular classification and the rank number of the portfolio in the particular classification. The user may select to view the comparisons in all classes in which the primary portfolio has patent assets or only the comparisons in a subset of the classes.

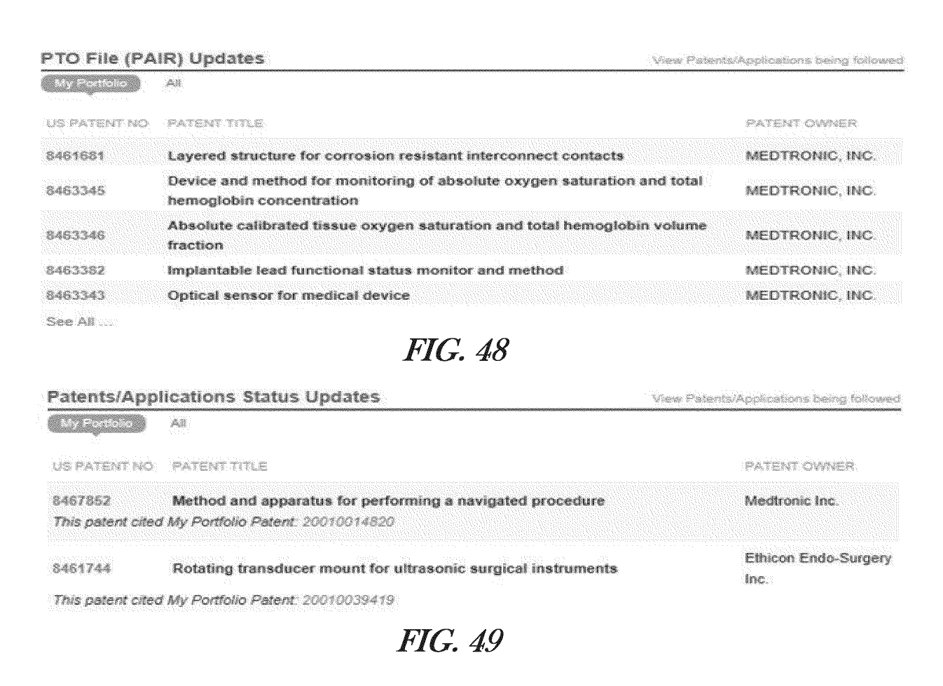

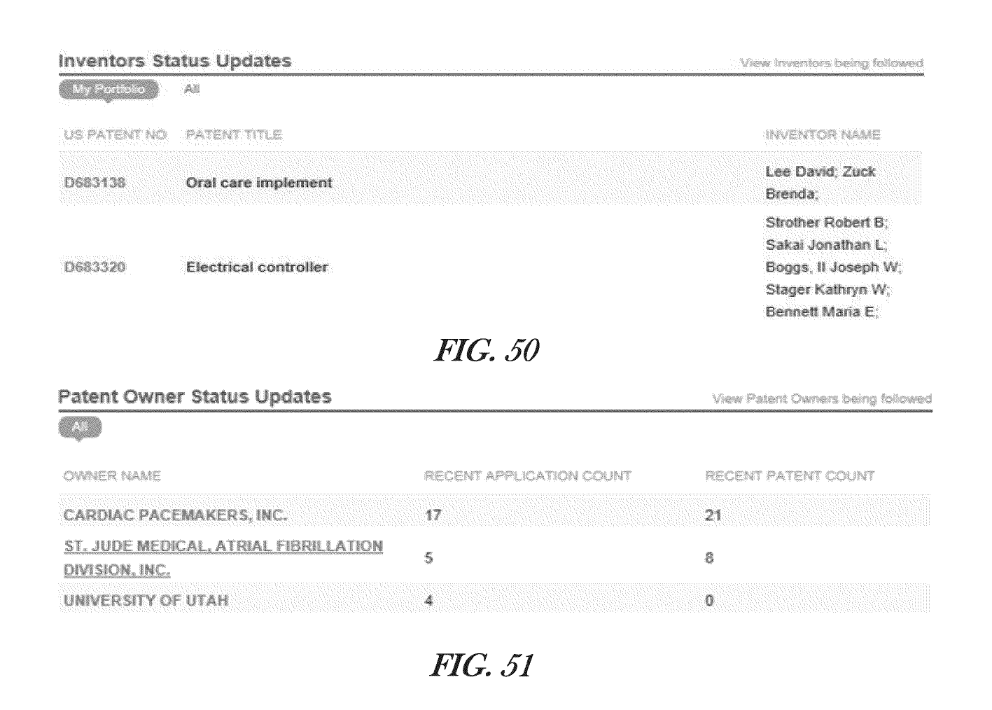

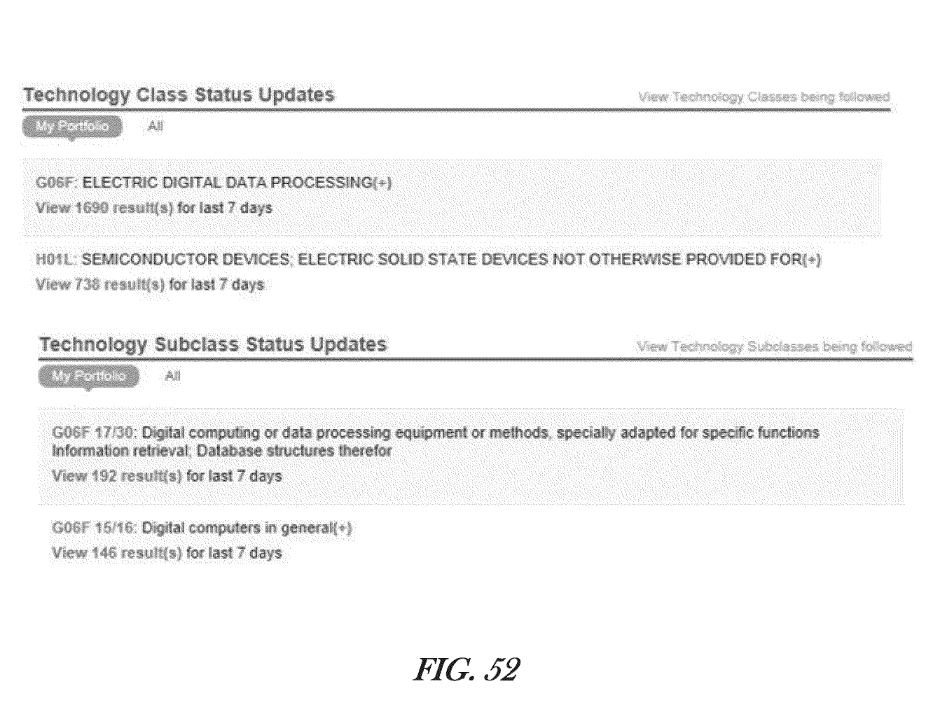

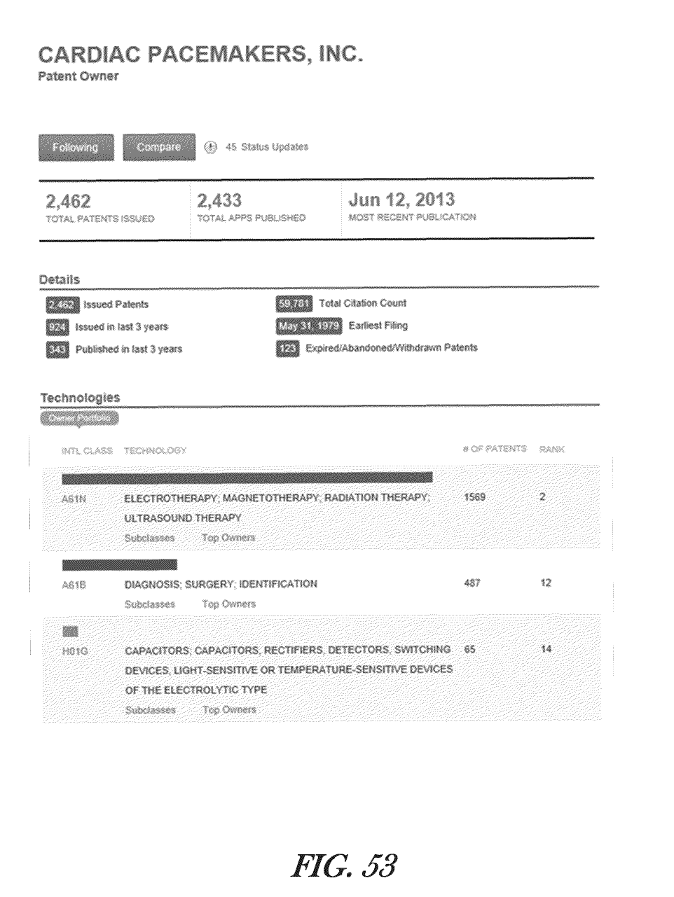

The patent portfolio management system may transmit an alert or notification to a user based on a watch set up by the user. The notification may alert the user to a variety of changes observed (or deduced, determined, or identified) by the portfolio management system or any of its tools. The portfolio management system may send notifications about
1) PAIR updates (e.g., a new office action has been issued), as shown in FIG. 48;
2) patent/application status update, as shown in FIG. 49;
3) inventor status changes (e.g., changed employment or a publication by the inventor), as shown in FIG. 50;
4) patent owner status updates, as shown in FIG. 51;
5) competitor updates (e.g., launched a new product);
6) technology areas updates by class or subclass, as shown in FIG. 52;
7) events that pertain to an organization's high value patent assets (e.g., patent granted); or
8) events that pertain to a competitor's high value patent assets, as shown in FIG. 53.

The portfolio management system may assist the inside counsel of an organization in managing the organization's outside counsel. The dashboard UI may be accessed using a browser or from an application of a mobile device. The UI of the portfolio management system provides both comprehensive views that include different levels of detail and concise views for portfolios, portfolio slices, and individual portfolio assets. The portfolio management system may also provide updates and alerts based on user-selected criteria to better monitor and manage patent portfolios. In some example embodiments, the portfolio management system may provide visual, auto-tagging or email alerts for PatentBuddy- or user-defined criteria that would alert the user when a patent, concentration of patents or prosecution activities, or citation activities of a patent owner exceed a preset or calculated value. For example, the portfolio management system issues a “Red Zone” threshold alert when a patent matter individually or collectively as a defined group, exceeds a limit of three Office Actions. In another example, the portfolio management system may notify a user when a competitor has filed one or more applications in a technology area based on one or more criteria specified by the user (e.g., the name of the competing entity, the threshold value for the number of applications filed, or the period of time specified for monitoring the competing entity). These notifications may be used to alert both a firm's prosecution counsel and a PatentBuddy user analyzing a patent or portfolio.

Further, upon receiving these alerts, the user may use the dashboard to view and analyze the change(s) to the patent, patent portfolio, or prosecution activities that served as basis for the alert(s) transmitted to the user. The dashboard may present a visual representation of a particular aspect of the portfolio reaching a pre-defined threshold value by, for example, tagging, highlighting, or otherwise delineating/emphasizing the changes that triggered the alert to be sent to the user. The evaluation of the change to the portfolio may be visually communicated to the user by being represented, for example, in a graphical, schematic, diagrammatic, gradation, or numerical form. The evaluation of changes to a patent, concentration of patents or prosecution activities, or citation activities may be performed based on the data of a dashboard or of a plurality of dashboards that are, for example, maintained by an organizational system as part of a network of dashboard that are secure and independent of each other.

In addition to presenting the data illustrative of a change to a patent, concentration of patents or prosecution activities, or citation activities, the dashboard may provide the user with a call to action. The call to action may vary in its degree of compulsion. For example, the dashboard may provide a suggestion with respect to an action the user may take based on the type of change that triggered the alert to the user. In another example, the dashboard may request that the user review the change detected with respect to the patent, concentration of patents or prosecution activities, or citation activities and engage in an action (e.g., undertake a particular activity) in response to the change.

Moreover, the dashboard may be a lead generator (e.g., may be used during a sales process). When a portfolio or identified patent owner meets a criterion (e.g., the patent owner owns a particular minimum number of patents or the new assignments value changes by a particular minimum number) that organization is identified as a possible sales lead/contact/target for another organization. A sales sheet may automatically be generated and populated with data that may be relevant during a sales call. The portfolio management system may transmit the sales sheet to a person responsible for making a sales call along with an alert that notifies the person of the change detected with respect to the patent, concentration of patents or prosecution activities, or citation activities.

In addition, certain portions of the data that pertains to the portfolio or a slice of the portfolio of the target organization may be marked in order to be analyzed by a dashboard user as part of a prosecution or portfolio management activity performed for the benefit of the other organization. Thus, in addition to triggering a notification about a change to a competitor's patent, portfolio, or prosecution activity to a dashboard user, the portfolio management system tags the dashboard information that reflects the change and identifies (e.g., suggests) certain activities that the user can engage in with respect to the user's portfolio in response to the change pertaining to the competitor's portfolio. For example, if a competitor amended certain claims in a patent application, the dashboard may obtain PAIR data for the competitor, identify the changes, present the competitor's claims including highlighted amendments to the dashboard user, and suggest that the dashboard user evaluate one or more of the dashboard user's claims in light of the changes made by the competitor.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

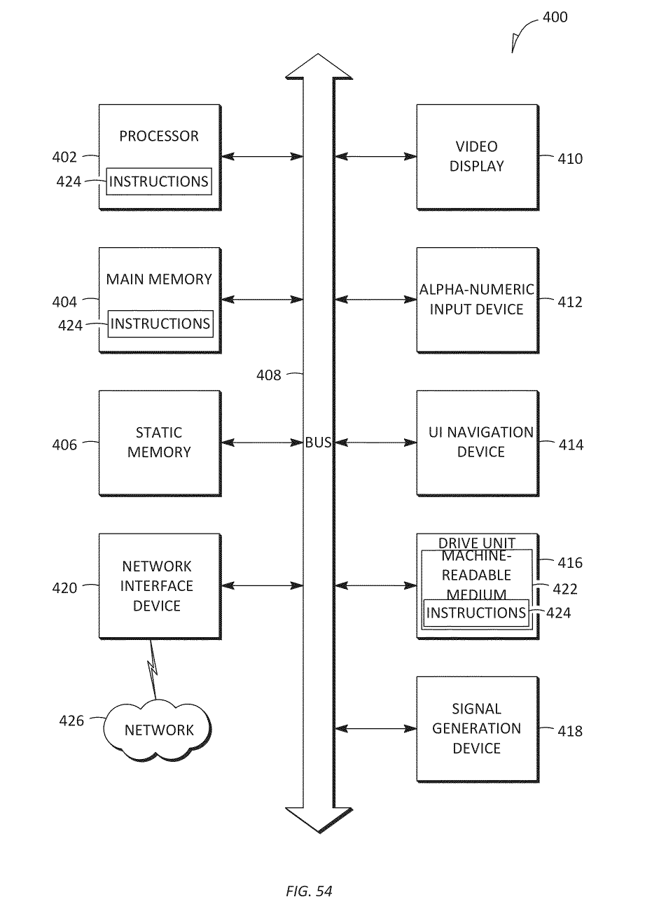

FIG. 54 is a block diagram of machine in the example form of a computer system 400 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 404 and a static memory 406, which communicate with each other via a bus 408. The computer system 400 may further include a video display unit 410 (e.g., a liquid crystal display (LCD) or a cathode ray tube (CRT)). The computer system 400 also includes an alphanumeric input device 412 (e.g., a keyboard), a user interface (UI) navigation device 414 (e.g., a mouse), a disk drive unit 416, a signal generation device 418 (e.g., a speaker) and a network interface device 420.

### Machine-Readable Medium

The disk drive unit 416 includes a machine-readable medium 422 on which is stored one or more sets of instructions and data structures (e.g., software) 424 embodying or utilized by any one or more of the methodologies or functions described herein. The instructions 424 may also reside, completely or at least partially, within the main memory 404 and/or within the processor 402 during execution thereof by the computer system 400, the main memory 404 and the processor 402 also constituting machine-readable media.

While the machine-readable medium 422 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 424 may further be transmitted or received over a communications network 426 using a transmission medium. The instructions 424 may be transmitted using the network interface device 420 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

1-2. (canceled)

3. A method of providing multiple views, the method comprising:
a. searching within a patent analytics database for a first set of metrics;
b. aggregating the first set of metrics;
c. providing a first level display corresponding to the aggregated first set of metrics;
d. receiving a selection request; and
e. navigating, in response to receiving the selection request, to a second level display, the second level display having a second set of metrics separate from the first set of metrics.

4. The method of claim 3 wherein the first level display relates to an individual patent, the selection request comprises a request to add the individual patent to a portfolio and the second level display relates to the portfolio.

5. The method of claim 4 wherein the first set of metrics includes patent analytics and the second set of metrics includes at least one of examination analytics and citation analytics.

6. The method of claim 3 wherein the first level display relates to a patent owner, the selection request comprises a request to add a grouping of patents associated with the patent owner to a portfolio and the second level display relates to the portfolio.

7. The method of claim 6 wherein the first set of metrics includes patent owner analytics and the second set of metrics includes at least one of examination analytics and citation analytics.

8. The method of claim 6 wherein the second level display relates to an individual patent.

9. The method of claim 8 wherein the first set of metrics includes patent owner analytics and the second set of metrics includes patent analytics.

10. The method of claim 3 wherein the first level display relates to an inventor, the selection request comprises a request to add a grouping of patents associated with the inventor to a portfolio and the second level display relates to the portfolio.

11. The method of claim 10 wherein the first set of metrics includes inventor analytics and the second set of metrics includes at least one of examination analytics and citation analytics.

12. The method of claim 10 wherein the second level display relates to an individual patent.

13. The method of claim 12 wherein the first set of metrics includes inventor analytics and the second set of metrics includes patent analytics.

14. A patent management system comprising:
i. a network;
ii. at least one patent analytics database, accessible on the network, and
iii. a server, operatively connected to the network, wherein the server includes:
1. a processor,
2. a memory,
3. software operable on the processor to:
a. search within the at least one patent analytics database for a first set of analytics;
b. aggregate the first set of analytics;
c. provide a first level display corresponding to the aggregated first set of analytics;
d. receive a selection request; and
e. navigate, responsive to the selection request, to a second level display, the second level display having a second set of analytics separate from the first set of analytics.

15. The system of claim 14 wherein the first level display relates to an individual patent, the selection request comprises a request to add the individual patent to a grouping of patents and the second level display relates to the grouping of patents.

16. The system of claim 15 wherein the first set of analytics includes bibliographic patent analytics and the second set of analytics includes at least one of examination analytics and citation analytics.

17. The system of claim 14 wherein the first level display relates to a patent owner, the selection request comprises a request to add a grouping of patents associated with the patent owner and the second level display relates to the grouping of patents.

18. The system of claim 17 wherein the first set of analytics includes bibliographic patent owner analytics and the second set of analytics includes at least one of examination analytics and citation analytics.

19. The system of claim 17 wherein the second level display relates to an individual patent.

20. The system of claim 19 wherein the first set of analytics includes bibliographic patent owner analytics and the second set of analytics includes bibliographic patent analytics.

21. The system of claim 14 wherein the first level display relates to an inventor, the selection request comprises a request to add a grouping of patents associated with the inventor and the second level display relates to the grouping of patents.

22. The system of claim 21 wherein the first set of analytics includes bibliographic inventor analytics and the second set of analytics includes at least one of examination analytics and citation analytics.

23. The system of claim 21 wherein the second level display relates to an individual patent.

24. The system of claim 23 wherein the first set of analytics includes bibliographic inventor analytics and the second set of analytics includes bibliographic patent analytics.
